(19) United States
(12) Patent Application Publication
(10) Pub. No.: US 2020/0183590 A1
(43) Pub. Date: Jun. 11, 2020

(54) DISTRIBUTED DATA STRUCTURES FOR SLIDING WINDOW AGGREGATION OR SIMILAR APPLICATIONS

(71) Applicants: BARCELONA SUPERCOMPUTING CENTER - CENTRO NACIONAL DE SUPERCOMPUTACIÓN, BARCELONA (ES); UNIVERSITAT POLITÈCNICA DE CATALUNYA, BARCELONA (ES)

(72) Inventors: David CARRERA PEREZ, BARCELONA (ES); Álvaro VILLALBA NAVARRO, TERRASSA (ES)

(73) Assignees: BARCELONA SUPERCOMPUTING CENTER - CENTRO NACIONAL DE SUPERCOMPUTACIÓN, BARCELONA (ES); UNIVERSITAT POLITÈCNICA DE CATALUNYA, BARCELONA (ES)

(21) Appl. No.: 16/604,523

(22) PCT Filed: May 30, 2017
(86) PCT No.: PCT/EP2017/063054

§ 371 Date: Oct. 10, 2019

(30) Foreign Application Priority Data
Apr. 12, 2017 (EP) 17382202.4

(51) Int. Cl. G06F 3/06; G06F 16/901; H04L 29/08

(52) U.S. Cl. CPC G06F 3/067; G06F 16/9027; G06F 3/0635; H04L 67/2852; G06F 3/0604; H04L 67/10

(57) ABSTRACT

Computer systems are provided for distributed storage of data structured as forests of balanced trees of nodes, each node including data-elements and the forests having levels. The nodes have first end nodes at first side of the forest, second end nodes at second side of the forest, and intermediate nodes between first and second end nodes. The computer systems have memories to store at least the first and second end nodes; connectors for implementing connections with storage systems storing intermediate nodes, so that exchange of nodes with the storage systems is performed through said connections; and processors to update the nodes stored in the memories according to updating criteria, and to exchange nodes with the storage systems through the connections according to exchange criteria. Storage systems are also provided, along with methods and computer programs that are performable by the computer systems.

The present disclosure relates to computer systems and storage systems for distributed storage of data structured as a forest of balanced trees suitable for e.g. sliding window aggregation or similar applications.

The present disclosure further relates to methods and corresponding computer programs suitable for being performed by such computer systems.

### BACKGROUND

It is known that data structures in the form of trees or forests of trees are used in various computational applications. In some applications, such tree-based structures may contain big amounts of data and, therefore, its computation may require large amounts of (execution) memory.

For example, the fast evolution of data analytics platforms has resulted in an increasing demand for real-time data stream processing. From Internet of Things applications to the monitoring of telemetry generated in large data centres, a common demand for currently emerging scenarios is the need to process vast amounts of data with low latencies, generally performing the analysis process as spatially close to the data source as possible.

Stream processing platforms are required to be versatile and absorb spikes generated by fluctuations of data generation rates. Data is usually produced as time series that have to be aggregated using multiple operators, sliding windows being one of the most common principles used to process data in real-time. To satisfy the above-mentioned demands, efficient stream processing techniques that aggregate data with minimal computational cost may be required.

Data streams are unbound sequences of ordered atomic updates (or data units) on the same information feature. For example, a stream associated with the temperature of a physical device D contains a sequence of updates of such temperature information coming from device D, each update substituting the previous one. Given that a stream emits updates indefinitely such sequences of updates cannot be traversed upstream as they do not have finite size and lack boundaries. Instead, selecting a limited window on the updates within a data stream is commonly considered one of the most affordable methods for analysing the data and information coming from a data source. It is for this kind of processing that projecting data from streams into sliding windows may be a convenient mechanism towards data analysis and aggregation.

A sliding window may be defined as an abstraction representing projections on data sequences, organized as First-In-First-Out (FIFO) structures containing elements of the same type (the data updates or data units from a data stream). Data updates may enter the sliding window when they are received from the data source (data stream), and may be removed according to a set of conditions or criteria. A sliding window may always contain the most recently generated updates or data units from a corresponding stream.

Applications that process data streams usually define a set of aggregation operations that when computed produce a result associated to the streams. Due to the unbound nature of streams, sliding windows are a convenient approach to processing such aggregations, by defining the subset of data units to be considered for processing. Therefore, for their computational purpose sliding windows may get associated with at least one aggregation function that is computed for the contained elements whenever the window content is updated.

An aggregation may be expressed as a monoid. A monoid is an algebraic structure with an associative binary operation and a neutral (or null) element. They have been extensively used in the literature for the implementation of data aggregations.

More formally, where S is a set and · is a binary operation, the operation composes a monoid if it obeys the following principles:

Associativity: For all a, b and c in S, the expression (a·b)·c=a·(b·c) is true.
Neutral element: There exists a value e in S that for all a the expression e·a=a·e=a is true.
Closure: For all a and b in S, the result of a·b is in S too.

In applications where data from data streams are processed by computer systems located as spatially close as possible to data sources, said computer systems are normally dimensioned with reduced size and restricted computational resources. For example, when data sources have large amounts of sensors distributed over a big city or similar scenario, lots of computer systems are used to provide all sensor sites with suitable processing functionalities. Spatial restrictions at the sensor sites may also condition the size and computational power of the computer systems.

When the same computer system is used to process data from different data streams, the aforementioned restrictions may result aggravated since computational resources are shared between different processes. This situation may occur in either the aforementioned distributed approach or even in a centralized approach where a central computer system receives data from lots of different data streams (sensor sites). In any of these cases, corresponding processes may thus result inefficient and/or unreliable in the context of e.g. streaming applications. If with the aim of solving these limitations, the computer systems are provided with more powerful resources, the whole system may result more expensive.

An object of the present disclosure is to improve prior systems, methods and computer programs aimed at processing data structured as tree-based arrangements, in particular, as forests of balanced trees implementing e.g. aggregation of data in a sliding window.

### SUMMARY

In an aspect, a computer system is provided for distributed storage of data structured as a forest of balanced trees of one or more nodes, each node including a plurality of data-elements, and the forest having a plurality of levels including a top level and a bottom or leaf level. The nodes in the forest have first end nodes at a first side of the forest, second end nodes at a second side of the forest, and intermediate nodes between the first and second end nodes.

The computer system has a memory to store at least the first and second end nodes, and a connector to implement a connection with a storage system configured to store intermediate nodes of the forest. Exchange of nodes with the storage system is performed (by the computer system) through said connexion.

The computer system further has a processor to update the nodes stored in the memory according to updating criteria, and to exchange nodes with the storage system through the connection according to exchange criteria.

The proposed computer system bases its operation on storing (and correspondingly updating) a forest such as the ones suggested in other parts of the description, with only a part of the forest in (execution) memory of the computer system. This may permit processing much larger forests in comparison with prior systems storing complete forests in memory. Hence, efficiency and/or reliability of e.g. aggregating data in a sliding window implemented by the “distributed” forest (in streaming applications) may be significantly improved.

Another advantage may be that several forests receiving data units from several data streams may implement corresponding sliding windows without the need of using excessive amounts of memory. Prior systems storing entire tree-based structures may need much more memory in comparison with computer systems according to the present disclosure.

The aforementioned advantages may be especially profitable in configurations that have many sensor sites provided with corresponding computer systems as spatially close as possible to the sensors. In these circumstances, relatively cheap computer systems according to the present disclosure may cooperate with corresponding storage system(s) to store higher numbers of forests and/or bigger forests. As described in other parts of the description, suitable transfer of nodes between computer and storage systems may be performed in order to have balanced amounts of data distributed between the computer and storage systems.

In a further aspect, a storage system is provided for distributed storage of data structured as a forest of balanced trees of one or more nodes, each node including a plurality of data-elements, and the forest having a plurality of levels including a top level and a bottom or leaf level. The nodes in the forest have first end nodes at a first side of the forest, second end nodes at a second side of the forest, and intermediate nodes between the first and second end nodes.

The storage system has a memory to store at least some of the intermediate nodes, and a connector to implement a connection with a computer system which is configured to store and update at least the first and second end nodes of the forest. Exchange of nodes with the computer system is performed (by the computer system) through said connexion.

Proposed storage system(s) may cooperate with corresponding computer system(s) for storing bigger forests and/or larger quantities of tree-based structures in a more efficient/reliable manner than prior art systems (storing whole tree-based structures). Details about said cooperation are provided in other parts of the description.

In some examples, a complete system may also be provided for distributed storage of data structured as a forest of balanced trees, the system having a computer system and a storage system such as the ones described before. The computer system and the storage system may be connectable (or connected) with each other through a connection between the connector of the computer system and the connector of the storage system. Once connected, the computer and storage systems may cooperate as described in other parts of the disclosure to store large forests and/or various forests.

In a still further aspect, a method is provided for updating distributed data structured as a forest of balanced trees of one or more nodes, each node including a plurality of data-elements, and the forest having a plurality of levels including a top level and a bottom or leaf level. The nodes in the forest have first end nodes at a first side of the forest, second end nodes at a second side of the forest, and intermediate nodes between the first and second end nodes.

The suggested method has storing, by a processor of a computer system, at least the first and second end nodes into a memory of the computer system, and updating, by the processor, the nodes stored in the memory according to updating criteria.

The method further has exchanging, by the processor, nodes with a storage system through a connection according to exchange criteria, the storage system being configured to store intermediate nodes of the forest, and the connection being implemented through a connector of the computer system.

The suggested method, which is based on principles described above with respect to computer and storage systems, may thus permit distributed storage of forests with larger amounts of data and/or various forests, in comparison with prior systems storing complete (forests of) tree-based structures.

In a yet further aspect, a computer program is provided having program instructions for causing a computer system to perform a method, such as e.g. the one described before, for updating distributed data structured as a forest of balanced trees. The computer program may be embodied on a storage medium and/or may be carried on a carrier signal.

### BRIEF DESCRIPTION OF THE DRAWINGS

Non-limiting examples of the present disclosure will be described in the following, with reference to the appended drawings, in which:

FIG. 1a is a schematic representation of computer and storage systems according to examples in the context of a first architecture;

FIG. 1b is a schematic representation of computer and storage systems according to examples in the context of a second configuration;

FIG. 1c is a block diagram of computer and storage systems connected to each other according to examples;

FIGS. 1d, 1e schematically illustrate a forest structure suitable for being stored and updated in a configuration with corresponding computer and storage systems, such as the ones depicted in previous figures;

FIG. 2 is a flowchart schematically illustrating a method according to examples for updating distributed data structured as a forest of balanced trees implementing a sliding window in a streaming application;

FIG. 3 is a flowchart schematically illustrating examples of inserting a data unit in a forest structure implementing a sliding window, in the context of a method such as the one shown in FIG. 2 or similar;

FIGS. 4a-4i schematically illustrate a forest structure and its evolution due to insertions of data units in the forest performed in same or similar way as shown in flowchart of FIG. 3;

FIG. 5 is a flowchart schematically illustrating further examples of inserting a data unit in a forest structure implementing a sliding window, in the context of a method such as the one shown in FIG. 2 or similar;

FIG. 6 is a flowchart schematically illustrating examples of determining from scratch partial results of a whole window aggregation in the context of a method such as the one shown in FIG. 2 or similar;

FIG. 7 shows the forest of FIG. 4i along with corresponding result node and stack updated according to sub-method of FIG. 6 or similar;

FIG. 8 is a flowchart schematically illustrating examples of deleting a data unit from a forest structure implementing a sliding window in the context of a method such as the one shown in FIG. 2 or similar;

FIGS. 9a-9h schematically illustrate a forest structure and its evolution due to deletion of data units performed in same or similar way as indicated in FIG. 8;

FIG. 10 is a flowchart schematically illustrating further examples of deleting data unit(s) from a forest structure implementing a sliding window in the context of a method such as the one shown in FIG. 2 or similar;

FIG. 11 is a flowchart schematically illustrating other examples of deleting data unit(s) from a forest structure implementing a sliding window in the context of a method such as the one shown in FIG. 2 or similar;

FIGS. 12a-12e show a window/forest and its evolution due to execution of a “massive” deletion sub-method such as the one of FIG. 11 or similar;

FIG. 13 is a flowchart schematically illustrating still further examples of deleting data unit(s) from a forest structure implementing a sliding window in the context of a method such as the one shown in FIG. 2 or similar; and

FIGS. 14a-14c show a window with corresponding forest, result node and stack and their evolution due to execution of a deletion sub-method such as the one of FIG. 13 or similar.

### DETAILED DESCRIPTION OF EXAMPLES

### Computer and Storage Systems

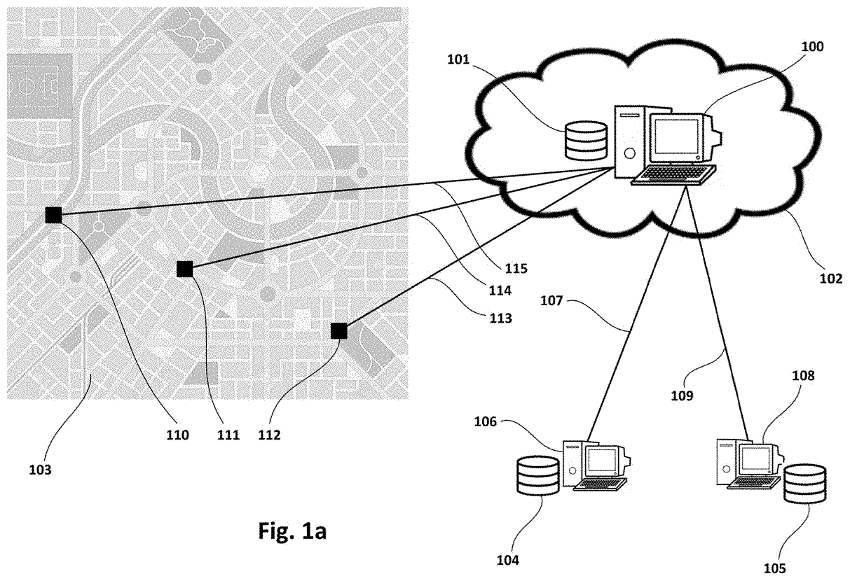

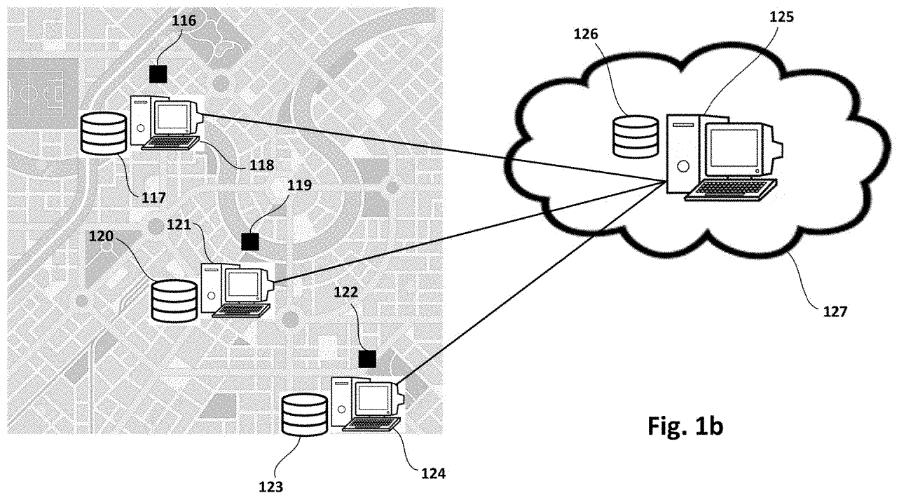

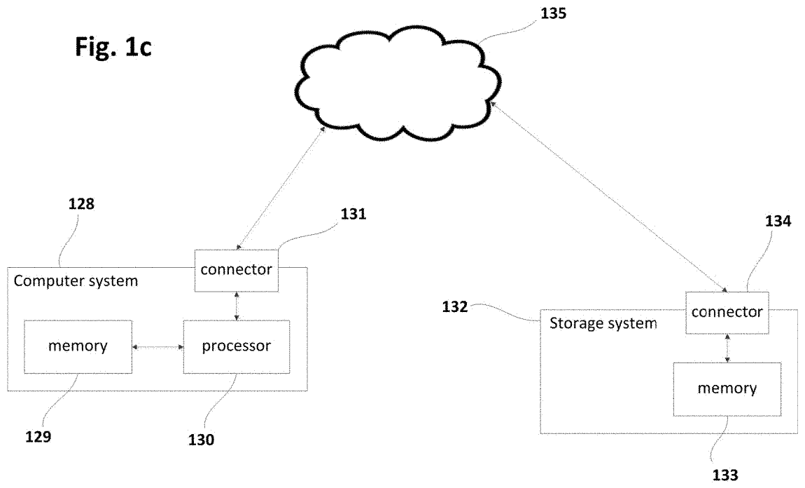

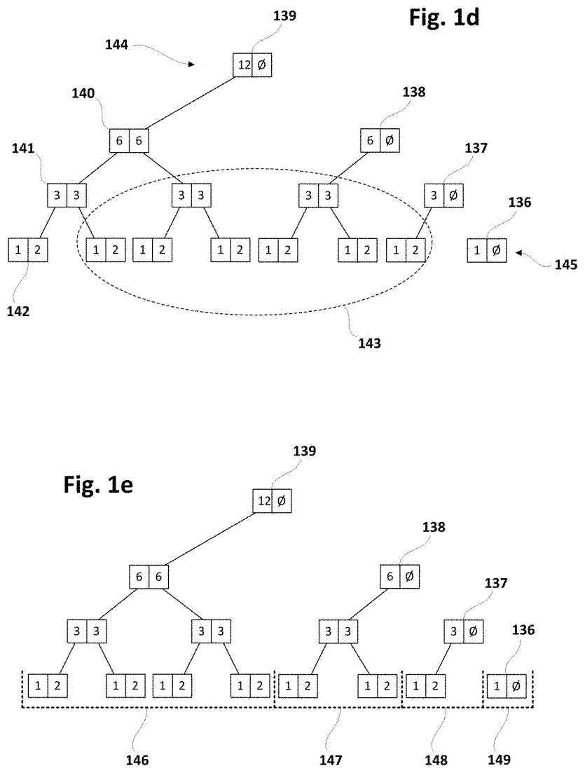

FIG. 1a is a schematic representation of computer and storage systems according to examples in the context of a first architecture. In this case, a centralized approach is illustrated including a single computer system 100 that receives data from a plurality of sensor sites 110-112.

The computer system 100 may be at the cloud 102 or may provide corresponding services through the cloud 102. The computer system 100 may be connected with a plurality of sensors 110-112 through suitable connections 113-115, respectively, in such a way that a stream of data generated from said sensors may be received by the system 100. Said connections 113-115 may be e.g. wireless or wired connections and, in some examples, may be implemented through a communications network such as e.g. Internet. The sensors may be e.g. temperature sensors, humidity sensors, pollution sensors, wind sensors, etc. installed at different locations of e.g. a city or town 103, a data processing centre, a factory, etc.

An intermediate system (not shown) may be intermediate between the sensors 110-112 and the computer system 100. This intermediate system may be configured to generate data streams aimed at providing data units from data produced by the sensors.

The system 100 may be connected with further systems 106, 108 through corresponding connections 107, 109, respectively. Said connections 107, 109 may be e.g. wireless or wired connections and, in some examples, may be implemented through a communications network such as e.g. Internet. Each of the further systems 106, 108 may have corresponding memory or storage device 104, 105, respectively. One of said further systems 106, 108 may be a storage system 106 according to the present disclosure.

Computer system 100 and storage system 106 may cooperate to store data structured as a forest of balanced trees in a distributed manner. That is, computer system 100 may store a part of the forest and storage system 106 may store the remaining part of the forest. Details about this distributed storage are provided in other parts of the description.

Another of the further systems 106, 108 may be a system 108 dedicated to e.g. consume data from the computer system 100 which may therefore act as a service/data provider. Aggregated data in the form of e.g. average values, maximum values, minimum values, etc. may be provided by the computer system 100 (through corresponding connection 109) to the consumer system 108. Then, said system 108 may process/analyse received aggregated data to e.g. determine corrective and/or preventive actions to at least attenuate distorting or harmful conditions inferred from the aggregated data.

FIG. 1b is a schematic representation of computer and storage systems according to examples in the context of a second configuration. This figure is similar to previous FIG. 1a. In this case, however, a decentralized approach is proposed including each of a plurality of sensor sites 116, 119, 122 provided with corresponding computer systems 118, 121, 124 according to the present disclosure, respectively.

Each of said computer systems 118, 121, 124 may have corresponding processor and memory 117, 120, 123 respectively, and may be connected to a storage system 125 with corresponding memory 126. The storage system 125 may be at the cloud 127, for example. Each computer system 118, 121, 124 may receive sensor data from its associated sensor site 116, 119, 122, respectively.

Similarly to previous FIG. 1a, each of the computer systems 118, 121, 124 and storage system 125 may cooperate to store data (from sensors) structured as a forest of balanced trees, respectively. That is, each of the computer systems 118, 121, 124 may store a part of corresponding forest and storage system 125 may store the remaining part of the forest. Details about this distributed storage are provided in other parts of the description.

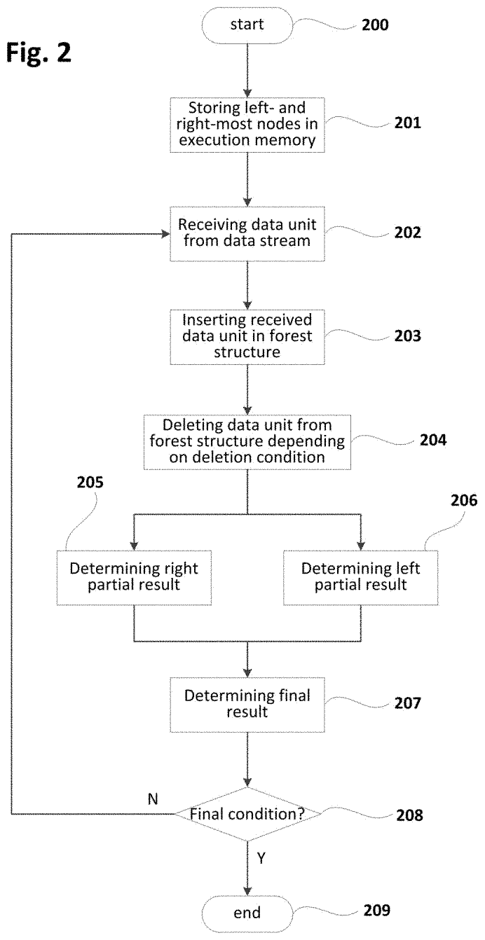

Any of the above computer systems 100, 118, 121, 124 may be implemented by a computer, a computer system, electronics or a combination thereof. The computer or computer system may be or may include a set of instructions (that is, a computer program) and then the computer or computer system 100, 118, 121, 124 may include a memory (or storage media) and a processor, embodying said set of instructions stored in the memory and executable by the processor. The instructions may include functionality to execute methods such as e.g. the ones described with reference to FIGS. 2-14c.

In case the computer or computer system 100, 118, 121, 124 is implemented only by electronics, the controller may be, for example, a microcontroller, a CPLD (Complex Programmable Logic Device), an FPGA (Field Programmable Gate Array) or an ASIC (Application-Specific Integrated Circuit).

In case the computer system 100, 118, 121, 124 is a combination of electronics and a computer, the computer may be or include a set of instructions (e.g. a computer program) and the electronics may be any electronic circuit capable of implementing the corresponding step or steps of the cited methods.

The computer program may be embodied on a storage medium (for example, a CD-ROM, a DVD, a USB drive, a computer memory or a read-only memory) or carried on a carrier signal (for example, on an electrical or optical carrier signal).

The computer program may be in the form of source code, object code, a code intermediate source and object code such as in partially compiled form, or in any other form suitable for use in the implementation of methods according to the present disclosure. The carrier may be any entity or device capable of carrying the computer program.

For example, the carrier may be or include a storage medium, such as a ROM, for example a CD ROM or a semiconductor ROM, or a magnetic recording medium, for example a hard disk. Further, the carrier may be a transmissible carrier such as an electrical or optical signal, which may be conveyed via electrical or optical cable or by radio or other devices or systems.

When the computer program is embodied in a signal that may be conveyed directly by a cable or other device or system, the carrier may be constituted by such cable or other device or system.

Alternatively, the carrier may be an integrated circuit in which the computer program is embedded, the integrated circuit being adapted for performing, or for use in the performance of, the relevant methods.

With respect to technical configuration of storage systems 106, 125, similar considerations to those commented with respect to computer systems 100, 118, 121, 124 may be attributed to storage system 106, 125. One difference is that storage systems 106, 125 may need lower computational capacities in comparison with computer systems, since storage systems 106, 125 are merely used to store data and exchange data with computer systems 100, 118, 121, 124.

Computer systems 100, 118, 121, 124 may aggregate data units from data stream(s) to e.g. continuously produce aggregated values (e.g. average, maximum, minimum . . . values) from sensor data.

Said aggregated values may be e.g. pollution values in the city 103. In further examples, the aggregated values may be e.g. temperature values in a data processing centre aimed at monitoring the state of different computers in the centre. In still further examples, the aggregated values may be e.g. temperature values in a factory with the purpose of monitoring the state of machinery in the factory.

FIG. 1c is a block diagram of computer and storage systems connected to each other according to examples. Computer system 128 may have a memory 129, a connector 131 and a processor 130.

Memory 129 may be configured to store at least the first and second end nodes of a forest of balanced trees according to the present disclosure. Details about examples of such forests are provided in other parts of the description with reference to other figures (see e.g. FIGS. 1d, 1e, 4a-4i, 7, 9a-9h, 12a-12e, 14a-14c and corresponding descriptions).

Connector 131 may be configured to implement a connection with storage system 132 which may be configured to store intermediate nodes of the forest (see e.g. FIGS. 1d, 1e and corresponding descriptions). Exchange of nodes or data-elements in the nodes with the storage system 132 may be performed through said connexion.

Processor 130 may be configured to update the nodes (or data-elements in the nodes) stored in the memory 129 according to updating criteria, and to exchange nodes (or data-elements) with the storage system 132 through the connection according to exchange criteria.

Storage system 132 may have or include a memory 133 for storing at least some of the intermediate nodes of the forest (see e.g. FIGS. 1d, 1e and corresponding descriptions). Storage system 132 may further have a connector 134 for implementing a connection with computer system 128 (storing and updating at least the first and second end nodes of the forest). Exchange of nodes (i.e. data-elements) with the computer system 128 may be performed through said connexion.

In the particular example shown, computer system 128 and storage system 132 may be connected to each other through a communications network 135, such as e.g. Internet. In particular, computer system 128 may be connected to the network 135 through connector 130 and storage system 132 may be connected to the network 135 through connector 134.

Principles commented with respect to FIG. 1c may be similarly applied to configurations described with reference to FIGS. 1a, 1b, and vice versa. Computer and storage systems have been previously described with respect to FIGS. 1a-1c as separate systems. However, it is also possible that, in some examples, the storage system is disposed in or as a part of the computer system.

FIGS. 1d, 1e schematically illustrate a forest structure suitable for being stored (and updated) in a configuration with corresponding computer and storage systems, such as the ones depicted in previous FIGS. 1a-1c.

In FIG. 1d, a particular forest is shown which may be stored in a distributed manner between corresponding computer and storage systems as the ones described above. This type of forest may be a forest of balanced trees of one or more nodes, each node including a plurality of data-elements. The forests may also have a plurality of levels including a top level 144 and a bottom or leaf level 145.

The nodes in the forest may have first end nodes 139-136 at a first side of the forest, second end nodes 139-142 at a second side of the forest, and intermediate nodes 143 between the first and second end nodes. In the particular example shown, first side is right side and second side is left side. For the sake of simplicity, this principle has been assumed in FIGS. 2-14c. In this sense, first end nodes 139-136 may be referred to as rightmost nodes, and second end nodes 139-142 may be referred to as leftmost nodes.

In other examples, the first side may be the left side and the second side may be the right side. In such a case, first end nodes 139-136 could be referred to as leftmost nodes, and second end nodes 139-142 could be referred to as rightmost nodes.

FIG. 1e shows that in forests of the proposed type, first end nodes (or, for reasons of simplicity, rightmost nodes) may be a root nodes of trees in the forest. In the particular example shown, the forest has leftmost tree 146 with rightmost node 139 as root node of said tree 146, next tree 147 with rightmost node 138 as root node of said tree 147, next tree 148 with rightmost node 137 as root node of said tree 148, and rightmost tree 149 with rightmost node 136 as root node of said tree 149.

In forests according to the present disclosure, such as the ones shown in FIGS. 1d and 1e, all data-elements in all intermediate nodes may be different from null. Besides, each of the first/second end nodes at non-top levels either may have all data-elements different from null, or have consecutive data-elements different from null and consecutive data-elements equal to null, the non-null data-elements being farther and the null data-elements being closer with respect to the first/second side of the forest, respectively.

As shown in FIGS. 1d, 1e and others (e.g. 4a-4i, 7, 9a-9h, 12a-12e, 14a-14c), only end nodes may have nulls in right data-elements at rightmost nodes and in left data-elements at leftmost nodes. The remaining data-elements may only be different from null.

Methods according to the present disclosure may generate and update a forest structure according to the above type, in which aggregations may be performed at a rightmost region and at a leftmost region of the forest. Hence, nodes of the forest that are in an intermediate region of the forest (i.e. outside the rightmost and leftmost regions) may be temporarily stored outside the computer system. This may cause that the amount of memory required in the computer system to be minimized. As commented before, nodes not stored in the memory of the computer system may be stored in a corresponding storage system.

The rightmost region of the forest may have the rightmost (or first end) nodes and, optionally, a number of consecutive intermediate nodes neighbouring the first end node (at each of the levels). The leftmost region of the forest may have the leftmost (or second end) nodes and, optionally, a number of consecutive intermediate nodes neighbouring the second end node (at each of the levels).

Aggregations in proposed methods may be performed through an aggregation function that has associative property and corresponding neutral (or null) element.

### Global View of Methods

FIG. 2 is a flowchart schematically illustrating a method according to examples for distributed storage of a forest of balanced trees. This method may further include determining a final aggregation of a sliding window for updating the forest in the context of a streaming application. This method (or similar) may be implemented as e.g. a computer program in a system such as the computer system 100 of FIG. 1a. This program may be iteratively executed so that all or part of data units received from data stream(s) may be processed according to the following principles.

Aggregations in methods according to the present disclosure may be performed using one or more associative binary operations which are also known as monoids. These operations may be commutative or not, and may include a neutral element that may be also referred to in the present disclosure as null or through symbol ‘Ø’.

At block 200, the method may be started as a result of detecting a starting condition such as e.g. upon reception of a petition requesting the start of the method. The starting condition may also correspond to e.g. reception of a data unit, i.e. block 200 may be triggered each time one or more data units are received from corresponding data stream(s).

At block 201, current leftmost and rightmost regions of the forest may be stored in the memory of the computer system, if they have not been already stored therein in previous executions of the method. Nodes not included in leftmost and rightmost regions may be stored in corresponding storage system, such as e.g. a remote database (storage system). This selective storing approach may be especially advantageous when computer systems are located as spatially close as possible to data source (e.g. sensor sites). Since only a small part of the forest may be stored in the computer system, its computational resources may be used more optimally and/or more forests of possibly larger size may be stored in (execution) memory. Bigger forest structures may increase efficiency and accuracy in determining e.g. final aggregations of the sliding window. Larger amounts of forests may permit processing data from more data streams.

Execution of the method may start from an empty forest or from a non-empty forest generated according to examples of methods according to the present disclosure. For example, the non-empty forest may result from previous iterations of same method.

At block 202, one or more data units (including e.g. a production time) may be received from corresponding data stream(s). The received data units may be stored in e.g. an input queue in production time order so that most recently produced data unit may be processed last.

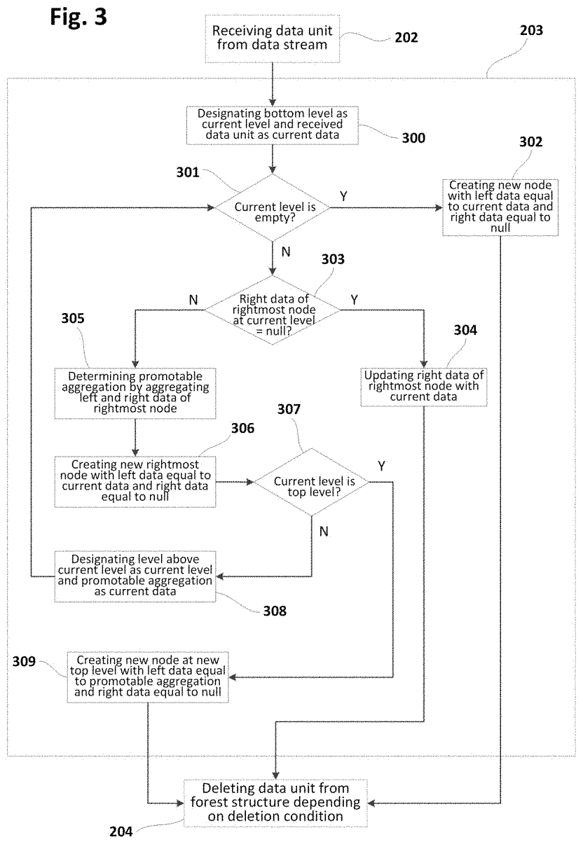

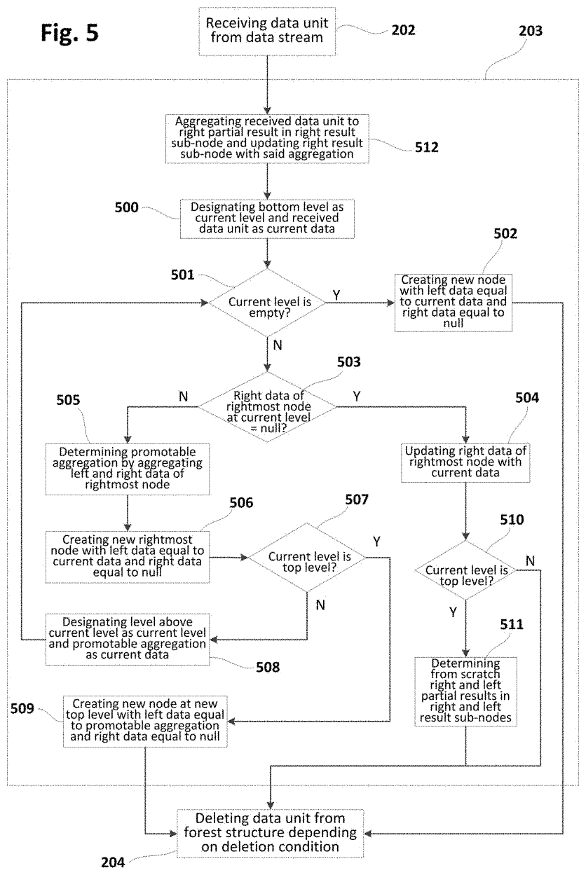

At block 203, a data unit (from e.g. input queue) may be inserted in a forest structure according to different approaches such as e.g. those shown in FIGS. 3 and 5 or similar. As commented before, data units may be inserted in the forest depending on production time, in such a way that the most recently produced data unit may be inserted last. Block 203 may be executed as many times as needed before continuing to next block. In particular, block 203 may be performed for each of the received data units according to production time order.

Insertion of a data unit may provoke, at any of the levels, creation of a new first end (or rightmost) node and transformation of a first end (or rightmost) node to intermediate node and, hence, an increase in the number of nodes at that level stored in the computer system. In this case, the computer system may send an intermediate node to the storage system for compensating such an increase. This rule may be implemented in a diversity of manners. For example, transfer of a given number of nodes (e.g. 10, 20, 30 or any other predefined amount) from computer system to storage system may be performed each time the number of nodes has been increased by a quantity equal or similar to said given number of nodes.

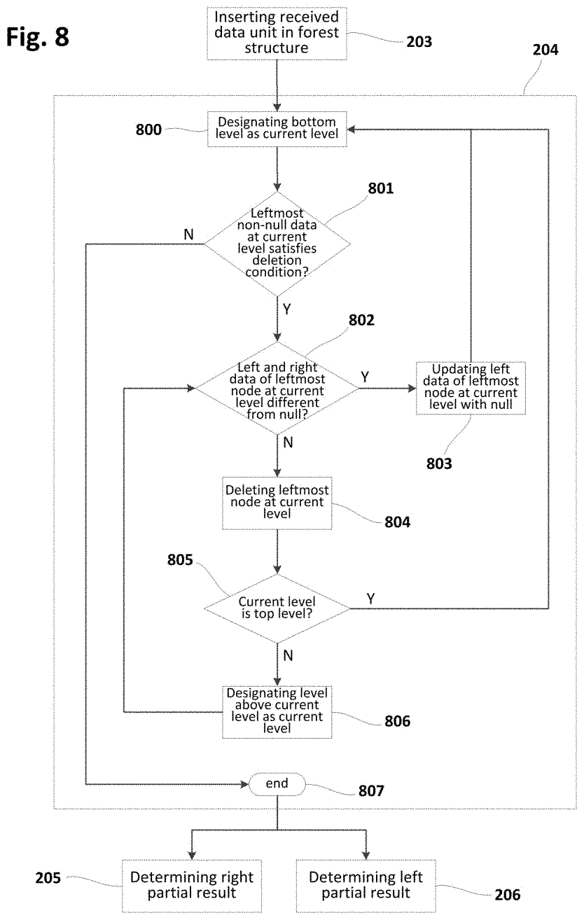

At block 204, the method may include a verification of whether a predefined deletion condition is satisfied. In case of positive (or true) result of said verification, data unit(s) may be deleted from the forest. Otherwise, no deletion may be carried out. Deletion condition may have e.g. a maximum number of data units in the forest in such a way that one or more deletions may be performed only when said maximum is achieved. Deletion of data unit(s) may be performed according to different approaches such as e.g. any of the ones shown in FIG. 8, 10, 11, 13 or similar.

Deletion of a data unit may provoke, at any of the levels, deletion of an existing second end (or leftmost) node and transformation of an intermediate node to new second end (or leftmost) node and, hence, a decrease in the number of nodes at that level stored in the computer system. In this case, the computer system may retrieve an intermediate node from the storage system for compensating such a decrease. This principle may be implemented in a diversity of manners. For example, transfer of a given number of nodes (e.g. 10, 20, 30 or any other predefined amount) from storage system to computer system may be performed each time the number of nodes has been decreased by a quantity equal or similar to said given number of nodes.

At block 205, a right partial result may be determined depending on rightmost nodes in the forest and, at block 206, a left partial result may be determined depending on leftmost nodes in the forest. Right and left partial results may be determined in different ways depending on how data units have been inserted in the forest and, in some circumstances, how data units have been deleted from the forest. Right and left partial results may be understood as partial aggregations corresponding to respective right and left portions of the forest whose combination results in the whole forest.

In some examples, if insertion/deletion of data units includes an incremental updating of a result node including right and left partial results, determining right and left partial results may include retrieving corresponding values from said result node.

In other examples without incremental updating of a result node, determining right partial result may include aggregating corresponding rightmost nodes, and determining left partial result may include aggregating corresponding leftmost nodes.

At block 207, a final aggregation of the whole window may be determined by aggregating right and left partial results determined at blocks 205 and 206 respectively. Final aggregation(s) or aggregated data may be processed or analysed to infer distorting or harmful conditions and accordingly determine corrective/preventive actions to at least attenuate said distorting or harmful conditions. This analysis of the aggregated data may be performed by the same computer system that produces the aggregated data, or by an external system that may be located at e.g. a remote location with respect to the computer system.

At block 208, the method may include a verification of whether a predefined ending condition is satisfied. In case of positive (or true) result of said verification, a transition to block 209 may be performed for ending the execution of the method. Otherwise, the method may loop back to block 202 for receiving new data unit(s) from data stream(s) and therefore starting a new iteration.

In some examples, the final condition may include a petition requesting completion of the method, in which case the method (computer program) may be completely finalized (at block 209). In other examples, the final condition may include a maximum elapsed time without receiving any data unit from data stream(s), in which case the method/program may be transitioned (at block 209) to standby state. At block 209, standby state may cause deactivation of the computer program while waiting for new data units and its reactivation upon reception of new data unit(s).

### Insertion

FIG. 3 is a flowchart schematically illustrating insertion of a data unit in a forest structure implementing a sliding window in the context of a method such as the one shown in FIG. 2 or similar. FIG. 3 includes some number references from FIG. 2 because it shows a possible implementation of block 203 (or similar) with corresponding previous block 202 (or similar) and subsequent block 204 (or similar).

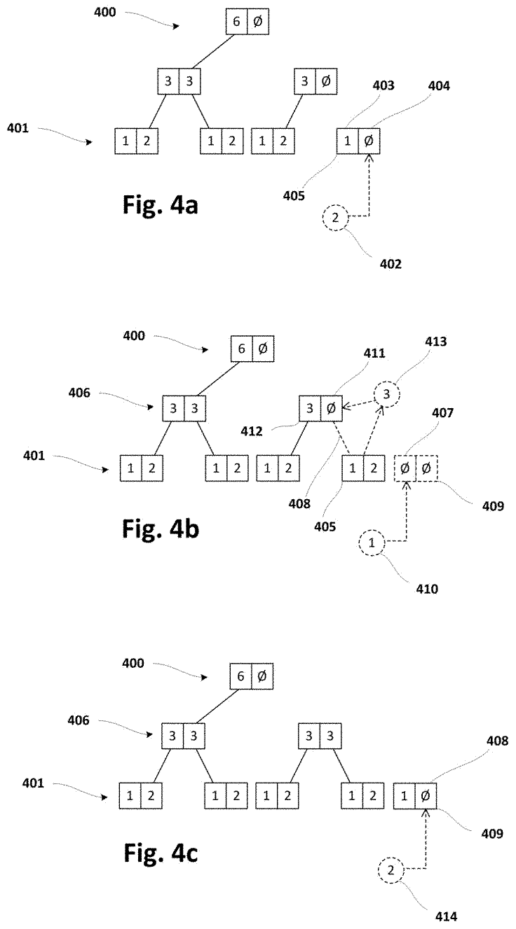

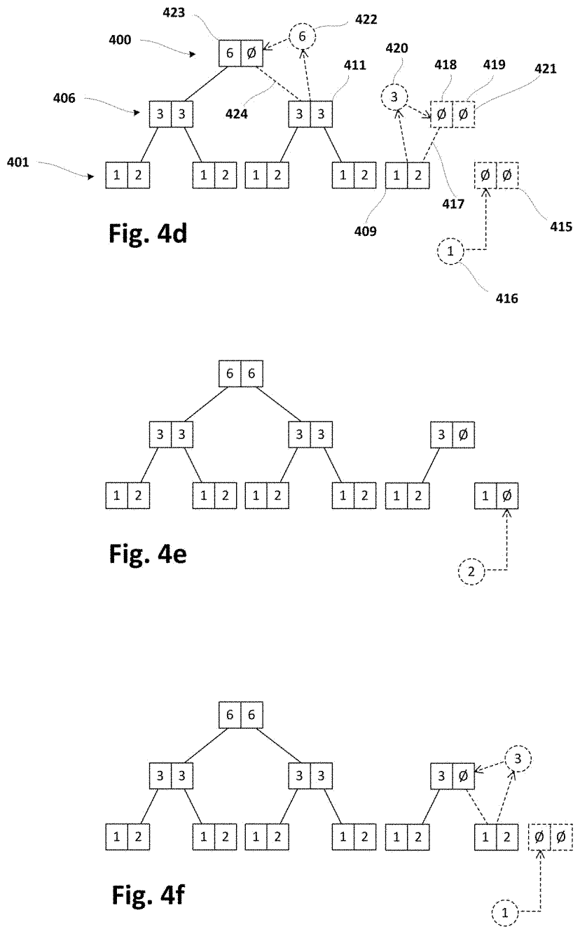

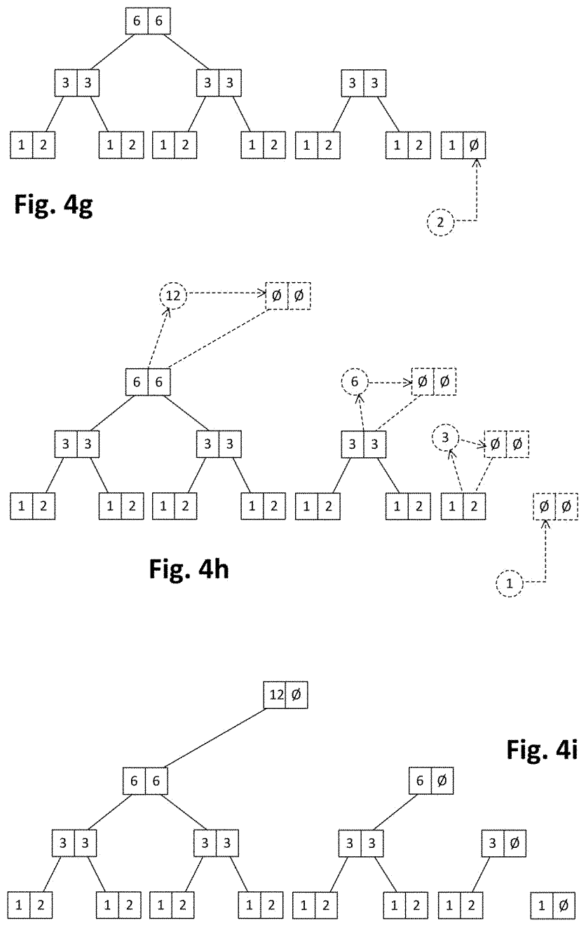

FIGS. 4a-4i schematically illustrate a forest structure and its evolution due to insertion of data units performed in same or similar way as indicated in FIG. 3. Symbol ‘Ø’ is utilized in FIGS. 4a-4i to indicate null or neutral element of corresponding monoid used to perform aggregations. Addition is used for performing aggregations in this particular example, even though any other monoid operation could be employed for that aim. For the sake of understanding, number references from FIGS. 4a-4i may be used in following description of FIG. 3.

The forests depicted in FIGS. 4a-4i have a bottom level 401 and a top level 400, and each of the levels may have a rightmost node. FIG. 4a shows an initial forest that may have been produced by methods according to the present disclosure starting from an empty forest. Rightmost node at bottom level 401 in said initial forest is indicated in FIG. 4a with number reference 405. FIGS. 4b-4i show different evolutions of said initial forest due to insertions performed according to flowchart of FIG. 3 or similar.

FIGS. 4a-4i show forests of binary trees for the sake of simplicity, but methods according to the present disclosure producing (and/or dealing with) forests of trees based on more than two dimensions are also possible.

At block 300, bottom level 401 of the forest may be designated (or set) as current level (i.e. level that is being processed in present iteration), and received data unit (from block 202) may be designated (or set) as current data.

At block 301, a verification of whether current level (of the forest) is empty may be performed, in which case a transition to block 302 may be performed and, otherwise, the method may continue to block 303.

At block 302, a new node may be created (in the memory of the computer system) with left data equal to current data (which corresponds to received data unit in first iteration) and right data equal to null (or neutral element). Once the new node has been created, the insertion of the data unit may be finalized by transitioning to block 204 (FIG. 2).

Left and right data of a given node in the forest may be defined with reference to FIG. 4a, a rightmost node 405 at bottom level 401 being shown with left data 403 equal to ‘1’ and right data 404 equal to ‘Ø’ (null or neutral element).

At block 303, a verification of whether right data 404 of rightmost node 405 at current level (bottom level 401 in first iteration) is equal to null may be performed. In case of positive (or true) result of said verification, the method may continue to block 304. Otherwise, a transition to block 305 may be performed.

At block 304, right data 404 of rightmost node 405 may be updated with current data (received data unit 402 equal to ‘2’ in FIG. 4a). Once said update has been performed, the insertion of the data unit may be finalized by transitioning to block 204 (FIG. 2).

At block 305, a promotable aggregation may be determined by aggregating left and right data of rightmost node at current level and, at block 306, a new rightmost node may be created (in the memory of the computer system) with left data equal to current data and right data equal to null. The expression “promotable aggregation” is used herein to indicate that said aggregation is to be promoted or propagated upwards in the forest.

FIG. 4b shows an example of determining a promotable aggregation and creating (in the memory of the computer system) a new rightmost node according to blocks 305 and 306 respectively. Promotable aggregation 413 (equal to ‘3’) results from aggregating left and right data (equal to ‘1’ and ‘2’ respectively) of rightmost node 405 (node 409 has not still been created) at current level (bottom level 401 in this case). Afterwards, new rightmost node 409 may be created (in the memory of the computer system) with left data 407 equal to current data (received data unit 410 equal to ‘1’ in this case) and right data equal to ‘Ø’ (null or neutral element).

FIG. 4b shows how said promotable aggregation 413 (equal to ‘3’) may be used in second iteration at block 304. In particular, it is shown that right data 411 of rightmost node 412 at intermediate level 406 (one level above bottom level 401) may be updated with promotable aggregation 413 (equal to ‘3’) determined at block 305 in previous iteration.

Once promotable aggregation has been determined (at block 305) and new rightmost node has been created (at block 306), a transition to block 307 may be performed.

At block 307, a verification of whether current level is top level 400 (FIG. 4a) may be performed. In case of positive (or true) result of said verification, the method may proceed to block 309. Otherwise, a transition to block 308 may be performed.

At block 308, the level above current level may be designated (or set) as current level and promotable aggregation may be designated (or set) as current data for levelling up in the forest in order to propagate the promotable aggregation upwards as many levels as required and, therefore, start a new iteration. To this end, a loop back from block 308 to block 301 may be performed.

At block 309, since a second node has been created at current top level, a new node at a new top level (above current top level) may be created (in the memory of the computer system), said new node having left data equal to promotable aggregation and right data equal to null. FIG. 4h shows an example of these circumstances and FIG. 4i shows a “final” forest resulting from said circumstances illustrated by FIG. 4h.

At least some of the FIGS. 4a-4i have been slightly referred to in previous description of FIG. 3 for facilitating the understanding of FIG. 3. Now, a more detailed description of FIGS. 4a-4i will be provided as an exemplary evolution of corresponding forest according to insertion sub-method of FIG. 3 or similar.

FIG. 4a shows that a new data unit 402 (from data stream) may be received and inserted as right data in rightmost node 405 at bottom level 401. Execution of the insertion sub-method may be ended because no new rightmost node has been created at current/bottom level 401, and a new execution of said sub-method may be initiated upon reception of a further data unit.

FIG. 4b shows that a new data unit 410 may be received but, in this case, said data unit 410 may not be inserted in rightmost node 405 because left and right data of said node 405 are different from null. Instead of that, promotable aggregation 413 may be determined and new rightmost node 409 may be created (in the memory of the computer system). Then, new data unit 410 may be inserted as left data 407 in said new rightmost node 409, and promotable aggregation 413 may be inserted as right data 411 in rightmost node 412 at intermediate level 401 (i.e. level above bottom level 401).

This last insertion may produce a consistent parent-child relation 408 between nodes 412 and 405 in the sense that aggregation of left and right data (‘1’+‘2’) of child node 405 is equal to right data 411 (=‘3’) of parent node 412. Execution of the insertion sub-method may be ended because no new rightmost node has been created at current/intermediate level 406, and a new execution of said sub-method may be initiated upon reception of a further data unit.

FIG. 4c shows that a new data unit 414 may be received and inserted as right data 408 in rightmost node 409 at bottom level 401. Execution of the insertion sub-method may be ended because no new rightmost node has been created at current/bottom level 401, and a new execution of said sub-method may be initiated upon reception of a further data unit.

FIG. 4d shows that a new data unit 416 may be received and said data unit 416 may not be inserted in rightmost node 409 because left and right data of said node 409 are different from null. Instead of that, promotable aggregation 420 may be determined and new rightmost node 415 may be created (in the memory of the computer system). Then, new data unit 416 may be inserted as left data in said new rightmost node 415. However, promotable aggregation 420 may not be inserted in rightmost node 411 at intermediate level 406 because left and right data of said node 411 are different from null.

Accordingly, another promotable aggregation 422 may be determined from node 411 at intermediate level 406 and new rightmost node 421 may be created at same intermediate level 406. Then, promotable aggregation 420 from bottom level 401 may be inserted as left data 418 in new rightmost node 421 (with right data 419 equal to null). This last insertion may produce a consistent parent-child relation 417 between nodes 421 and 409 in the sense that aggregation of left and right data (‘1’+‘2’) of child node 409 is equal to left data 418 (=‘3’) of parent node 421.

Once intermediate level 406 has been “processed”, a transition from current level to next level upwards in the forest may be performed in order to compute next level (top level) 400. In this case, promotable aggregation 422 from intermediate level 406 may be inserted as right data in the only existing node 423 at top level 400. This last insertion may produce a consistent parent-child relation 424 between nodes 423 and 411 in the sense that aggregation of left and right data (‘3’+‘3’) of child node 411 is equal to right data (=‘6’) of parent node 423. Execution of the insertion sub-method may be then ended because no new rightmost node has been created at current/top level 400, and a new execution of said sub-method may be initiated upon reception of a further data unit.

FIGS. 4e-4i show subsequent evolutions of the forest without using reference numbers because underlying principles have been sufficiently explained with reference to FIGS. 4a-4d. These further evolutions of the forest are described herein in order to clearly reflect how the forest may achieve a situation in which a new top level may be created.

FIG. 4e shows that new data unit (equal to ‘2’) may be received and inserted as right data in the rightmost node at bottom level. Execution of the insertion sub-method may then be ended because no new rightmost node has been created at current/bottom level.

FIG. 4f shows that new data unit (equal to ‘1’) may be received and promotable aggregation (equal to ‘3’) may be determined from rightmost node at bottom level (because left and right data in rightmost node are different from null). This figure also shows that new rightmost node may be created at bottom level and new data unit may be inserted as left data in new rightmost node at bottom level. It is further shown in present figure that promotable aggregation from bottom level may be inserted as right data in rightmost node at intermediate level. Execution of the insertion sub-method may then be ended because no new rightmost node has been created at current/intermediate level.

FIG. 4g shows that new data unit (equal to ‘2’) may be received and inserted as right data in the rightmost node at bottom level. Execution of the insertion sub-method may then be ended because no new rightmost node has been created at current/bottom level.

FIG. 4h shows that new data unit (equal to ‘1’) may be received and promotable aggregation (equal to ‘3’) may be determined from rightmost node at bottom level (because left and right data in said rightmost node are different from null). This figure also shows that new rightmost node may be created at bottom level and new data unit may be inserted as left data in said new rightmost node at bottom level. It is further shown that promotable aggregation (equal to ‘6’) may be determined from rightmost node at intermediate level (because left and right data in said rightmost node are different from null).

FIG. 4h further shows that new rightmost node may be created at intermediate level and promotable aggregation from bottom level may be inserted as left data in said new rightmost node. Promotable aggregation (equal to ‘12’) may be determined from the rightmost and only existing node at top level (because left and right data in said node are different from null). Afterwards, promotable aggregation from intermediate level may be inserted as left data in new rightmost node at top level, so that consistent parent-child relation may be defined between new rightmost node at top level and previous rightmost node at intermediate level.

FIG. 4h finally shows that new node may be created at new top level and promotable aggregation from previous top level may be inserted as left data in said new node at new top level. This last insertion implies that consistent parent-child relation may be defined between new node at new top level and previous rightmost node at previous top level. Execution of the insertion sub-method may then be ended since new node has been created at new top level.

FIG. 4i shows a final forest that may result from previous circumstances (evolutions) illustrated by FIGS. 4a-4h. That is, the final forest may result from receiving several new data units (from data stream) and performing insertion sub-method according to FIG. 3 for each of the received data units. Constructing the forest in such a manner may permit determining right partial result (block 205 of FIG. 2) from rightmost nodes at non-top levels and left partial result (block 206 of FIG. 2) from leftmost nodes at all the levels, as indicated below. Final result (i.e. aggregation of whole window) may be determined by aggregating said right and left partial results (block 207 of FIG. 2).

Right partial result may be determined by aggregating left and right data of rightmost nodes at non-top levels:

Bottom level=>‘1’+‘Ø’
First level above bottom level=>‘3’+‘Ø’
Second level above bottom level=>‘6’+‘Ø’
Right partial result=>‘1’+‘Ø’+‘3’+‘Ø’+‘6’+‘Ø’=‘10’.

Left partial result may be determined by aggregating the leftmost non-null data at bottom level and right data of leftmost nodes at all the levels having left and right data different from null (i.e. top-level node <12, Ø> is discarded):

Bottom level=>‘2’
First level above bottom level=>‘3’
Second level above bottom level=>‘6’
Leftmost non-null data at bottom level=>‘1’
Left partial result=>‘2’+‘3’+‘6’+‘1’=‘12’.

Accordingly, final aggregation of whole window may be equal to ‘22’ which results from aggregating right partial result (=‘10’) and left partial result (=‘12’).

FIG. 5 is a flowchart schematically illustrating an insertion sub-method similar to the insertion sub-method of FIG. 3. In particular, blocks 500-509 (of FIG. 5) may be equal or similar to blocks 300-309 (of FIG. 3) respectively. FIG. 5 may differ from FIG. 3 in blocks 510-512 which are aimed at incrementally updating a result node having right and left result sub-nodes for storing left and right partial results respectively. The result node may reside in the memory of the computer system.

At block 512, new data unit (received from data stream) may be aggregated to right partial result in right result sub-node and right result sub-node may be updated with said aggregation. This implies that right result sub-node may be incrementally updated as new data units are received and inserted in the forest.

At block 510, a verification of whether only existing node at top level has been updated (at block 504) may be performed. In case of positive (or true) result of said verification, a transition to block 511 may be performed. Otherwise, the sub-method may be finalized and may proceed to e.g. block 204 (if no more insertions are to be performed).

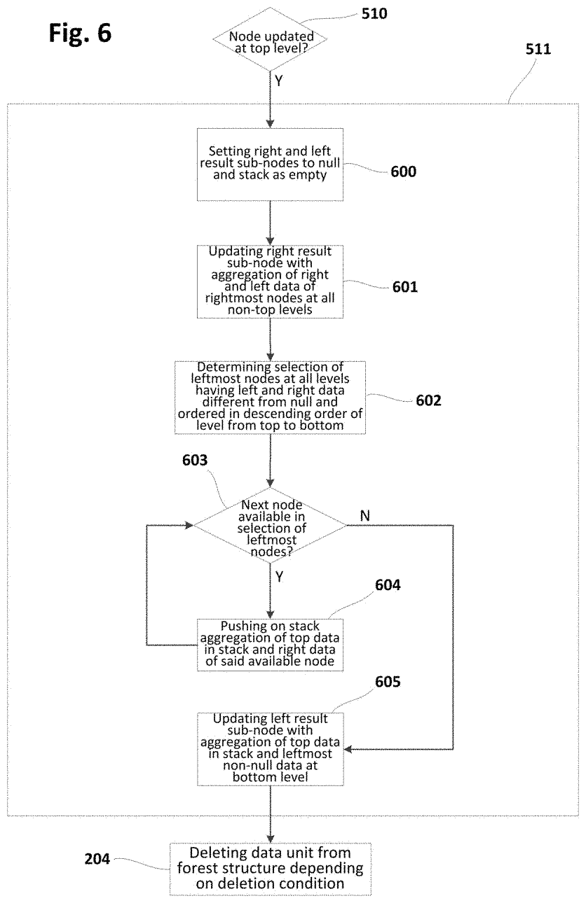

At block 511, right and left partial results in right and left result sub-nodes may be determined from scratch, in a similar way as previously described with reference to FIG. 4i. In particular, right partial result may be determined by aggregating left and right data of rightmost nodes at non-top levels of the forest. Left partial result may be determined by aggregating leftmost non-null data at bottom level and right data of leftmost nodes having left and right data different from null at all the levels of the forest. FIG. 6 illustrates a sub-method of example for determining right and left partial results from scratch (by inspecting rightmost nodes at non-top levels and leftmost nodes at all the levels).

Once block 511 has been completed, the sub-method may be finalized or may be repeated in order to insert a new data unit received from data stream. If the sub-method is finalized, a transition to e.g. block 204 may be performed.

If right result sub-node has been updated according to proposed sub-method, right partial result may be directly retrieved from result node (at block 205 of FIG. 2). Similarly, if left result sub-node has been updated according to proposed sub-method, left partial result may be directly retrieved from left result sub-node (at block 206 of FIG. 2). This may cause that at least some methods according to the present disclosure may be more efficient in terms of optimal use of computational resources.

### Partial Results Generation

FIG. 6 is a flowchart schematically illustrating an example of sub-method implementing block 511 (of FIG. 5) for determining right and left partial results from scratch. In this example, a stack is used to store partial aggregations corresponding to left partial result (or aggregation). This stack may reside in the memory of the computer system.

At block 600, right and left result sub-nodes may be initialized to null (or neutral element) and stack may be initialized to empty. Then, the sub-method may proceed to next block 601.

At block 601, right result sub-node may be updated with aggregation of left and right data of rightmost nodes at all non-top levels. Then, the sub-method may proceed to next block 602.

At block 602, a selection of leftmost nodes with left and right data different from null at all levels of the forest may be determined. Said selection may be ordered in descending (top-down) order of level. Then, a transition to next block 603 may be performed.

At block 603, a verification of whether a next node is available (i.e. not yet processed) in the selection of leftmost nodes may be performed. In first iteration, next available node may be first node in the selection (if not empty). In case of positive (or true) result of said verification, the sub-method may proceed to block 604. Otherwise, a transition to block 605 may be performed.

At block 604, an aggregation of top data in the stack and right data of said next node from the selection may be determined. Then, said aggregation may be pushed on the stack to keep track of corresponding partial aggregation at leftmost region of the forest. In the case that stack is empty, top data in the stack may be assumed as null (or neutral element). Once stack has been accordingly updated, the sub-method may loop back to previous block 603 in order to process next available node (if it exists) in the selection.

At block 605, an aggregation of top data in the stack and leftmost non-null data at bottom level may be determined. Then, left result sub-node may be updated with said aggregation which corresponds to left partial result or aggregation. In the case that stack is empty, top data in the stack may be assumed as null (or neutral element). The leftmost non-null data at bottom level may be e.g. left data in leftmost node at bottom level if said left data is not null, or right data in leftmost node at bottom level if said right data is not null and left data is null. Once the left result sub-node has been updated the sub-method may be finalized by transitioning from block 605 to e.g. block 204 of FIG. 2 or similar.

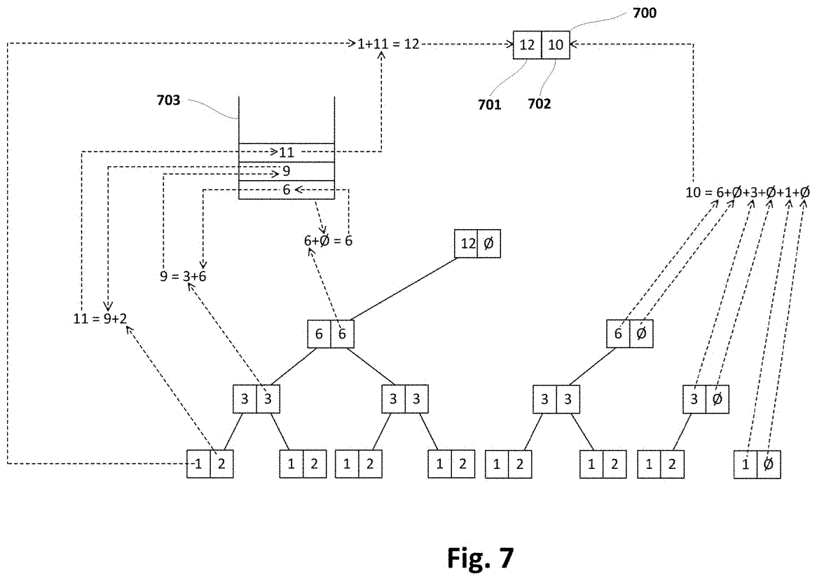

FIG. 7 shows the forest of FIG. 4i along with corresponding result node 700 and stack 703 updated according to sub-method of FIG. 6. Left partial result may be determined by retrieving it from left result sub-node 701 in result node 700 (block 206 of FIG. 2). Right partial result may be determined by retrieving it from right result sub-node 702 in result node 700 (block 205 of FIG. 2). Final result (or aggregation) may be determined by aggregating the retrieved left and right partial results (block 207 of FIG. 2).

### Removal

FIG. 8 is a flowchart schematically illustrating a sub-method of deleting a data unit from a forest structure implementing a sliding window in the context of a method such as the one shown in FIG. 2 or similar.

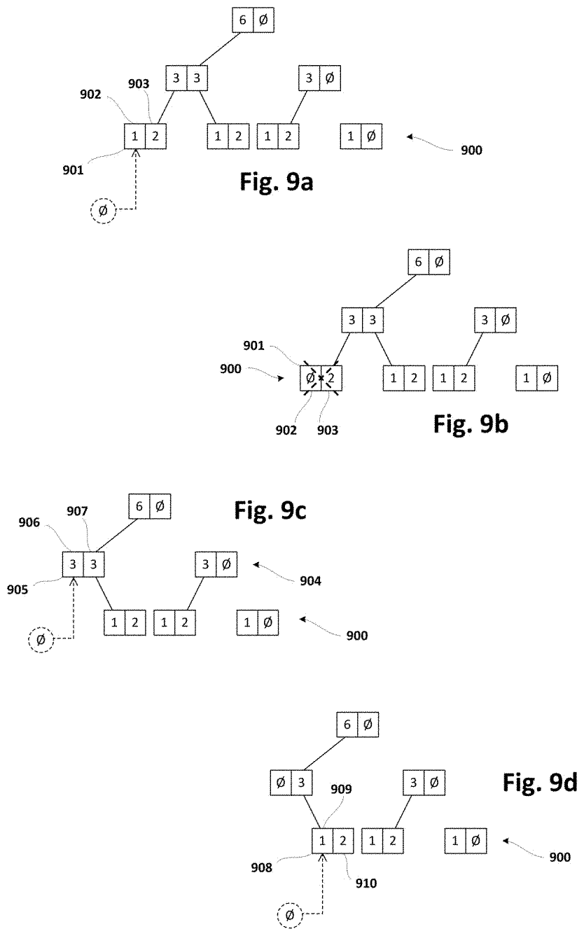

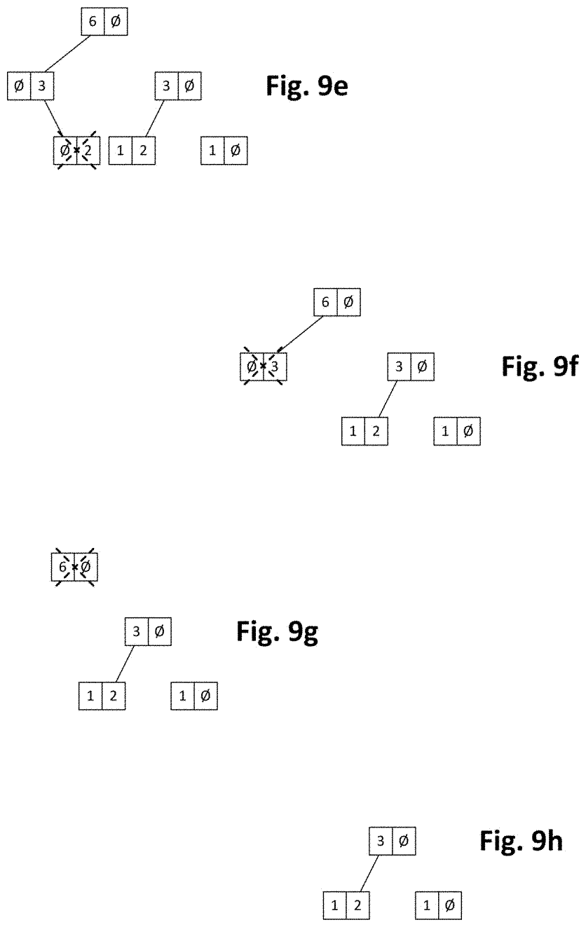

FIGS. 9a-9h schematically illustrate a forest structure and its evolution due to deletion of data units performed in same or similar way as indicated in FIG. 8. Symbol ‘Ø’ is utilized in FIGS. 9a-9h to indicate null or neutral element of corresponding monoid used to perform aggregations. For the sake of understanding, number references from FIGS. 9a-9h may be used in following description of FIG. 8.

At block 800, bottom level may be designated (or set) as current level and, then, a transition to next block 801 may be performed. In the example of FIG. 9a, bottom level is indicated with number reference 900.

At block 801, a verification of whether leftmost non-null data at current/bottom level satisfies a predefined deletion condition may be performed. In case of positive (or true) result of said verification, the sub-method may proceed to block 802. Otherwise, the sub-method may continue to block 807 for causing termination of the sub-method.

In the example of FIG. 9a, leftmost non-null data at bottom level corresponds to left data 902 of leftmost node 901 (equal to ‘1’). In the example of FIG. 9b, leftmost non-null data at bottom level corresponds to right data 903 of leftmost node 901 (equal to ‘2’) since its left data 901 is null.

A predefined deletion condition may include e.g. compliance that number of aggregated updates (received data units) in the window cannot exceed a maximum number of updates. That is, a count excess (with respect said maximum) may be reduced to zero in order to cause satisfaction of the deletion condition. In order to implement that, a dimension of the aggregation could be a count of updates. If count value in a considered partial aggregation is less or equal than the count excess in the whole window aggregation, data in the window corresponding to said partial aggregation may be removed according to deletion condition.

Another deletion condition may include compliance that aggregated updates (received data units) in the window cannot be outside a specific lapse of time such as e.g. an hour. To this end, each received data unit may include a timestamp corresponding to when the data unit has been produced. A dimension of the aggregation could be a timestamp maximum, so that if the timestamp value in a considered partial aggregation is older than the lapse of time specified by the deletion condition, data in the window corresponding to said partial aggregation may be removed according to deletion condition.

At block 802, once it has been determined (at block 801) that leftmost non-null data at bottom level satisfies deletion condition, a verification of whether left and right data of the leftmost node at current level are not null may be performed. In case of positive (or true) result of said verification, the sub-method may proceed to block 803. Otherwise, a transition to block 804 may be performed.

In the example of FIG. 9a, the verification of block 802 may produce positive (or true) result since both left and right data 902, 903 of the leftmost node 901 (at bottom level 900) are different from null. In the example of FIG. 9b, the verification of block 802 may produce negative (or false) result since left data 902 of the leftmost node 901 (at bottom level 900) is null.

At block 803, once it has been determined (at block 802) that left and right data of leftmost node at current level are not null, left data of the leftmost node at current level may be updated with null. Then, the sub-method may loop back to block 800 in order to initiate a new iteration starting again from bottom level. FIG. 9a shows that left data 902 of leftmost node 901 at bottom level 900 is updated with null (according to block 803), and FIG. 9c shows that left data 906 of leftmost node 905 at intermediate level 904 is updated with null (according to block 803).

At block 804, once it has been determined (at block 802) that left data of the leftmost node at current level is null, leftmost node at current level may be deleted. Then, a transition to block 805 may be performed in order to verify whether the deleted node corresponds to top level. FIG. 9b shows that leftmost node 901 at bottom level 900 is deleted (according to block 804) because left data 902 of said node is null. FIG. 9f shows that leftmost node at intermediate level is deleted (according to block 804) because left data of said node is null.

At block 805, once leftmost node at current level has been deleted, a verification of whether said deleted node corresponds to top level may be performed. In case of positive (or true) result of said verification (node deleted at top level), the sub-method may loop back to block 800 in order to initiate a new iteration starting again from bottom level. Otherwise (node deleted at non-top level), a transition to block 806 may be performed for levelling up in the forest.

At block 806, once it has been verified that the deleted node does not correspond to top level, the level above current level may be designated as current level, i.e. a transition from current level to next level upwards in the forest may be performed. Then, the sub-method may loop back to block 802 in order to initiate a new iteration for inspecting the leftmost node at said next level upwards (block 802) and updating its left data with null (block 803) or deleting it (block 804) depending on whether its left and right data are null or not.

At least some of the FIGS. 9a-9h have been slightly referred to in previous description of FIG. 8 for facilitating the understanding of FIG. 8. Now, a more detailed description of FIGS. 9a-9h will be provided as an exemplary evolution of corresponding forest according to deletion sub-method of FIG. 8 or similar.

FIG. 9a shows that left and right data 902, 903 of the leftmost node 901 at bottom level are not null and, therefore, left data 902 of said leftmost node 901 may be updated with null.

FIG. 9b illustrates that a new iteration may be initiated starting again from bottom level because left data 902 of node 901 has been updated with null (see FIG. 9a). It is also shown that leftmost node 901 at bottom level 900 may be deleted because its left data 902 is null.

FIG. 9c shows that a transition from bottom level 900 to next level upwards (intermediate level) 904 may be performed because leftmost node 901 at bottom level 900 has been deleted and said deletion has not been performed at top level (see FIG. 9b). It is further shown that left data 906 of leftmost node 905 at intermediate level 904 may be updated with null because its left and right data 906, 907 are not null.

FIG. 9d shows that a new iteration may be initiated starting again from bottom level because left data 906 of node 905 has been updated (see FIG. 9c). It is further shown that left data 909 of leftmost node 908 at bottom level 900 may be updated with null because left and right data 909, 910 of said leftmost node 908 are not null.

FIGS. 9e-12h illustrate subsequent evolutions of the forest without using reference numbers because underlying principles have been sufficiently explained with reference to FIGS. 9a-9d. These further evolutions of the forest are described herein in order to clearly reflect how the forest may achieve a situation that may result from deleting a node at top level.

FIG. 9e illustrates that a new iteration may be initiated starting again from bottom level because left data 909 of node 908 has been updated with null (see FIG. 9d). It is also shown that leftmost node at bottom level may be deleted because its left data is null.

FIG. 9f shows that a transition from bottom level to next level upwards (i.e. intermediate level) may be performed because leftmost node at bottom level has been deleted and said deletion has not been performed at top level (see FIG. 9e). It is further shown that leftmost node at said intermediate level may also be eliminated because its left data is null.

FIG. 9g shows that a transition from intermediate level to next level upwards (i.e. top level) may be performed because leftmost node at intermediate level has been deleted and said deletion has not been performed at top level (see FIG. 9f). It is further shown that leftmost node at top level may also be eliminated because its right data is null.

FIG. 9h illustrates that a new iteration may be initiated starting again from bottom level because deletion at top level has been performed. It is also shown that deletion sub-method may be terminated because deletion condition is not satisfied by left data of leftmost node at bottom level. In this case, the deletion condition may restrict the number of received data units (at bottom level) to a maximum of three data units. Since the number of left/right data at bottom level different from null is three (‘1’, ‘2’, ‘1’), the deletion condition is satisfied and, hence, the deletion sub-method may be terminated.

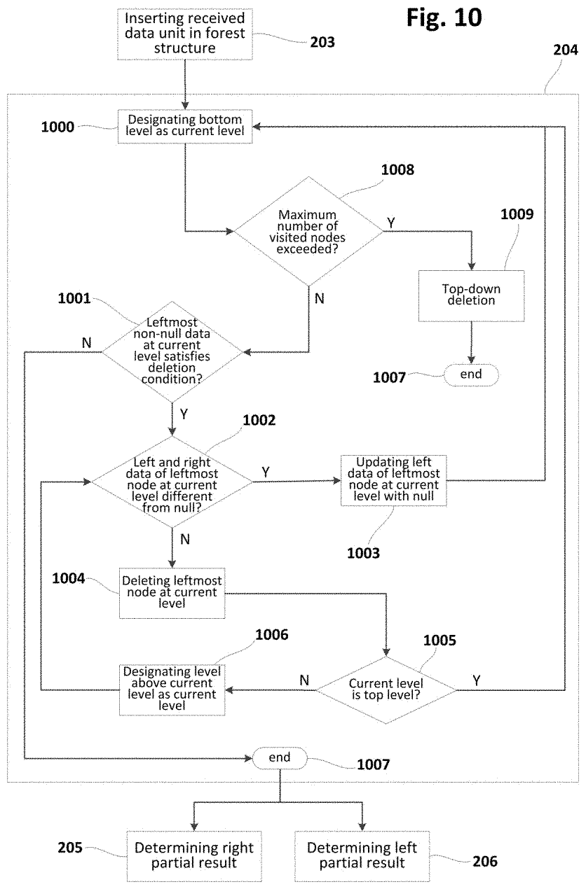

FIG. 10 is a flowchart schematically illustrating a deletion sub-method similar to the deletion sub-method of FIG. 8. In particular, blocks 1000-1007 (of FIG. 10) may be equal or similar to blocks 800-807 (of FIG. 8) respectively. FIG. 10 may differ from FIG. 8 in blocks 1008, 1009 which are aimed at changing the modality under which nodes are being deleted. This change may cause e.g. a transition from one by one deletion mode (blocks 1000-1007) to massive (top-down) deletion mode (block 1009).

At block 1008, a verification of whether a maximum number of visited (or inspected) nodes has been reached or exceeded may be performed. In case of positive (or true) result of said verification, deletion sub-method may continue to block 1009 for changing deletion modality from one by one deletion to massive (top-down) deletion. Otherwise, a transition to block 1001 may be performed for continuing deletion of nodes under one by one deletion modality. The maximum number of visited (or inspected) nodes may be a predefined maximum that may e.g. be proportional to the number of levels of current forest. That is to say, predefined maximum may be equal to e.g. N*L, L being the number of levels of current forest and N being a predefined number equal or greater than 1.

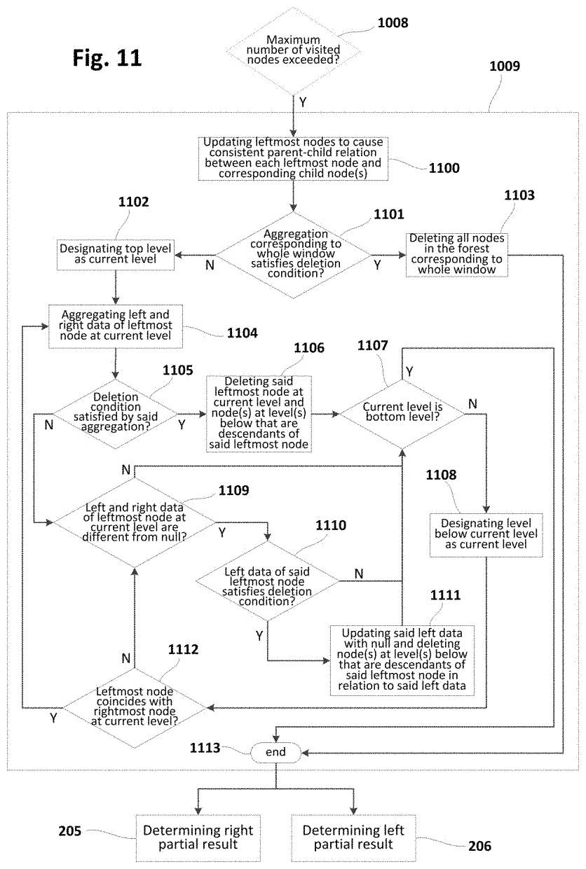

At block 1009, a massive top-down deletion may be performed according to e.g. deletion sub-method illustrated by FIG. 11. This change to massive deletion mode may thus be performed when one by one deletion mode is estimated to likely be inefficient (e.g. when predefined maximum of inspected nodes has been exceeded). This approach may generally improve efficiency of deletion sub-method and, therefore, cause a more optimal use of computational resources. Once massive top-down deletion has been completed, a transition to final block 1007 may be undertaken.

FIG. 11 is a flowchart schematically illustrating other examples of deleting data unit(s) from a forest structure implementing a sliding window in the context of a method such as the one shown in FIG. 2 or similar. In this case, a massive (top/down) deletion sub-method is proposed in order to e.g. compensate for anticipated possible inefficiencies derived from one by one deletion. In this particular approach, the forest may be seen as a sequence of partial aggregations (implemented in the forest/window) that may be inspected from largest to smallest, and finally excluded or not (from the forest/window) depending on whether said inspection results in satisfaction of the deletion condition by corresponding partial aggregation. Exclusion of a given partial aggregation (in the forest/window) may be performed by deleting all nodes of sub-forest structure corresponding to said partial aggregation.

As defined in other parts of the description, deletion condition may correspond to a restricted count of existing updates (or data units) in the window, a restricted lapse of production time of updates (or data units) in the window, etc.

At block 1100, leftmost nodes of the forest may be inspected and (if necessary) updated for causing consistent parent-child relations (as defined in other parts of the description) between each of the leftmost nodes and corresponding child node(s). This inspection (and update if needed) of leftmost nodes may be aimed at e.g. correcting possible parent-child inconsistencies derived from previous one by one deletion.

At block 1101, a verification of whether aggregation corresponding to whole window satisfies deletion condition may be performed. Aggregation corresponding to whole window may be seen as first partial aggregation in the abovementioned sequence of (largest to smallest) partial aggregations. In case of positive (or true) result of said verification, the sub-method may continue to block 1103 for deleting all nodes corresponding to said largest aggregation. Otherwise, the sub-method may proceed to block 1102 for transitioning to next partial aggregation in the sequence of partial aggregations. Aggregation corresponding to whole window may be determined in any of the manners described in present disclosure. For example, in implementations including result node incrementally updated, the aggregation corresponding to whole window may be determined by aggregating left and right partial results from result node.

At block 1103, all the nodes in the forest (corresponding to whole window) may be deleted since it has been determined (at block 1101) that aggregation corresponding to whole window satisfies deletion condition. Once all nodes have been deleted, a transition to final block 1113 may be performed for terminating the sub-method.

At block 1102, top level may be designated as current level for initiating corresponding computations along the sequence of partial aggregations starting from top level.

At block 1104, left and right data of leftmost node at current level may be aggregated, said aggregation corresponding to next partial aggregation in the sequence of partial aggregations. This step may thus be seen as a transition to next partial aggregation corresponding to whole leftmost node at current/top level.

At block 1105, it may be verified whether said partial aggregation (corresponding to whole leftmost node at current level) satisfies deletion condition. In case of positive (or true) result of said verification, the sub-method may continue to block 1106 for deleting all nodes corresponding to said partial aggregation. Otherwise, the sub-method may proceed to block 1109 for transitioning to next partial aggregation.

At block 1106, leftmost node at current level (corresponding to partial aggregation determined at block 1104) may be deleted along with nodes at levels below current level that are descendants of said leftmost node. Descendant nodes of a particular node may be defined as those nodes included in any sub-tree hanging from said particular node. This “massive” deletion of nodes may be implemented in different manners, such as e.g. by marking nodes as deleted so that a background process may physically eliminate them under more favourable computational conditions. For example, execution of background process may be differed to when computational load is below a threshold, or background process may be run by an auxiliary computer system, etc. In the case that nodes to be eliminated are simply marked as deleted, the proposed sub-method may include ignoring said marked nodes as if they did not exist in the forest.

At block 1109, it may be verified whether left and right data of leftmost node at current level are not null. In case of positive (or true) result of said verification, it means that next partial aggregation corresponds to left data of said leftmost node and, hence, transition to block 1110 may be performed. Otherwise, it means that no other partial aggregation may be determined from said leftmost node (partial aggregation corresponding to aggregation of left and right data of said leftmost node has already been determined at block 1104). In this case, transition to block 1107 may thus be performed for transitioning to next level downwards if bottom level has not still been reached.

At block 1110, it may be verified whether left data of leftmost node at current level satisfies deletion condition. In case of positive (or true) result of said verification, the sub-method may proceed to block 1111 for eliminating partial aggregation corresponding to left data of said leftmost node. Otherwise, transition to block 1107 may be performed for transitioning to next level downwards if bottom level has not still been reached.

At block 1111, partial aggregation corresponding to left data of leftmost node at current level may be eliminated by updating said left data with null and deleting nodes at levels below current level that are descendants of said nulled left data. Descendant nodes of a particular data of a given node may be defined as those nodes included in a sub-tree hanging from said particular data of the given node. This “massive” deletion of nodes may be implemented in different manners according to e.g. the principles commented with respect to block 1106.

At block 1107, a verification of whether current level is bottom level may be performed. In case of positive/true result of said verification (i.e. bottom level has been reached), the sub-method may be terminated by proceeding to final block 1113. Otherwise, the sub-method may continue to block 1108 for transitioning to next level downwards in the forest. To this end, level below current level may be designated (or set) as current level at block 1108. Then, the sub-method may continue to block 1112 for transitioning to next partial aggregation in the forest/window.

At block 1112, it may be verified whether transition to next level downwards in the forest (performed at block 1108) has caused transition to new top level because previous deletions have eliminated prior top level. This verification may be performed by determining whether leftmost node coincides with rightmost node at current level (as indicated in the figure). In case of positive/true result of said verification (current level is new top level), the sub-method may loop back to block 1104 for transitioning to next partial aggregation corresponding to leftmost node at (new) top level. Otherwise (current level is not new top level), the sub-method may loop back to block 1109 for transitioning to next partial aggregation corresponding to leftmost node at the non-top level to which block 1108 has transitioned downwards in the forest.

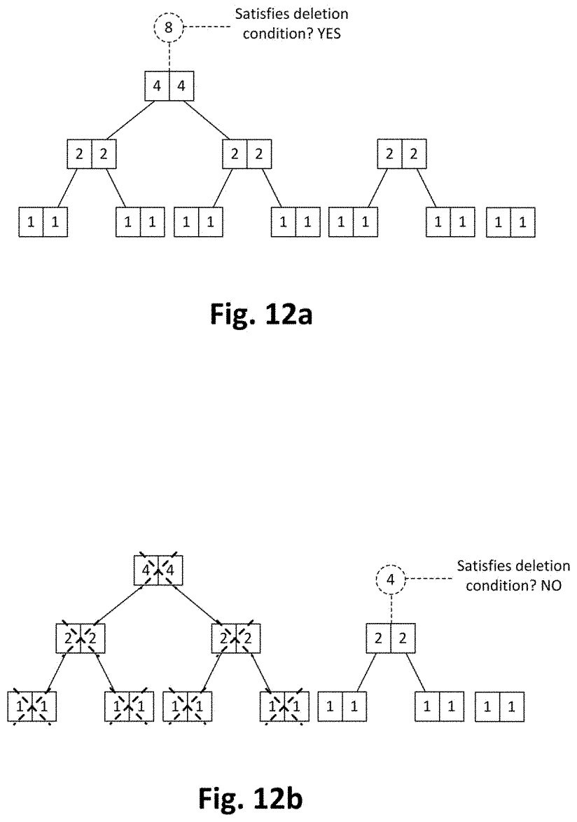

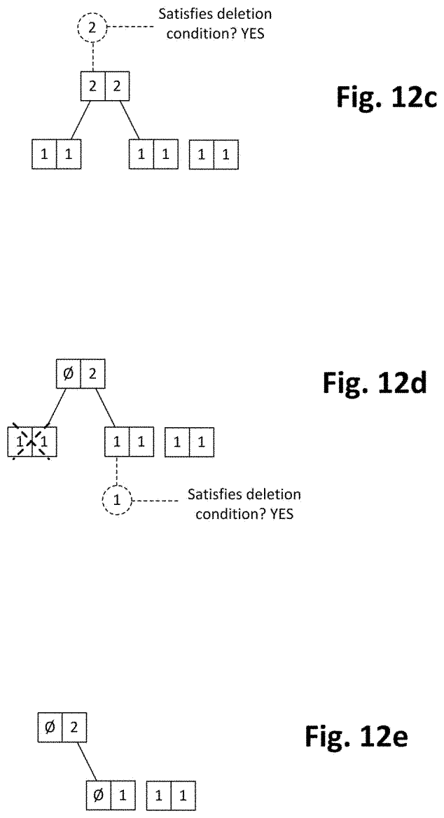

FIGS. 12a-12e show a window/forest and its evolution due to execution of a “massive” deletion sub-method such as the one of FIG. 11 or similar.

FIG. 12a shows a forest structure that may have been constructed by performing a method according to the present disclosure. FIGS. 12b-12e illustrate evolutions of said forest/window due to massive deletions performed according to sub-method of FIG. 11 or similar.

In FIG. 12a, it is assumed that aggregation corresponding to whole window does not satisfy deletion condition (block 1101) and, hence, first iteration starting from top level may be initiated (block 1102). Then, transition to next partial aggregation in the window may be performed by aggregating left and right data of leftmost node at current/top level: ‘4’+‘4’=‘8’ (block 1104).

Next, it may be determined that said partial aggregation (‘4’+‘4’=‘8’) satisfies deletion condition (block 1105), in which case transition to block 1106 may be performed for deleting all nodes corresponding to said partial aggregation. FIG. 12b shows such a deletion including removal of leftmost node at current/top level <‘4’, ‘4’> and deletion of nodes at levels below that are descendants of said leftmost node (block 1106).

FIG. 12b further shows that progression to next partial aggregation may be performed as follows. It may be verified that current level is not bottom level (block 1107), in which case transition to next level downwards in the forest may be executed (block 1108). Then, it may be verified that new level to which the sub-method has transitioned is top level as a result of previous deletions (block 1112), in which case a loop back to block 1104 may be performed for initiating new iteration starting again from top level.

FIG. 12b also shows that, according to previous circumstances, next partial aggregation may correspond to aggregation of left and right data of leftmost node at top level: ‘2’+‘2’=‘4’ (block 1104), which may be assumed as not satisfying the deletion condition (so indicated in the figure). Dissatisfaction of the deletion condition may thus be confirmed (block 1105). Next, it may be confirmed that left and right data of leftmost node at current/top level <‘2’, ‘2’> are not null (block 1109).

Afterwards, it may be determined that left data ‘2’ of leftmost node at current/top level <‘2’, ‘2’> satisfies deletion condition (block 1110) according to assumption indicated in FIG. 12c. Next, since said left data ‘2’ satisfies deletion condition, it may updated with null and nodes that are descendants of said leftmost node <‘2’, ‘2’> in relation to its left data ‘2’ may be deleted (block 1111). FIG. 12d shows such update of left data ‘2’ with null ‘Ø’ and corresponding deletion of descendant node <‘1’, ‘1’>.

FIG. 12d also shows transition to next partial aggregation based on that current/top level is not bottom level (block 1107), transition to next level downwards (bottom level) has been performed (block 1108), bottom level is not top level (block 1112), and left and right data of leftmost node at bottom level are not null (block 1109). According to these circumstances, next partial aggregation corresponds to left data ‘1’ of leftmost node at bottom level <‘1’, ‘1’>, which is assumed to satisfy the deletion condition (as indicated in the figure).

Once said left data ‘1’ of leftmost node at bottom level <‘1’, ‘1’> has been confirmed to satisfy deletion condition (block 1110), said left data ‘1’ may be updated with null ‘Ø’ (block 1111), as illustrated in FIG. 12e. Finally, since current level is bottom level (block 1107) the sub-method may be terminated (block 1113).

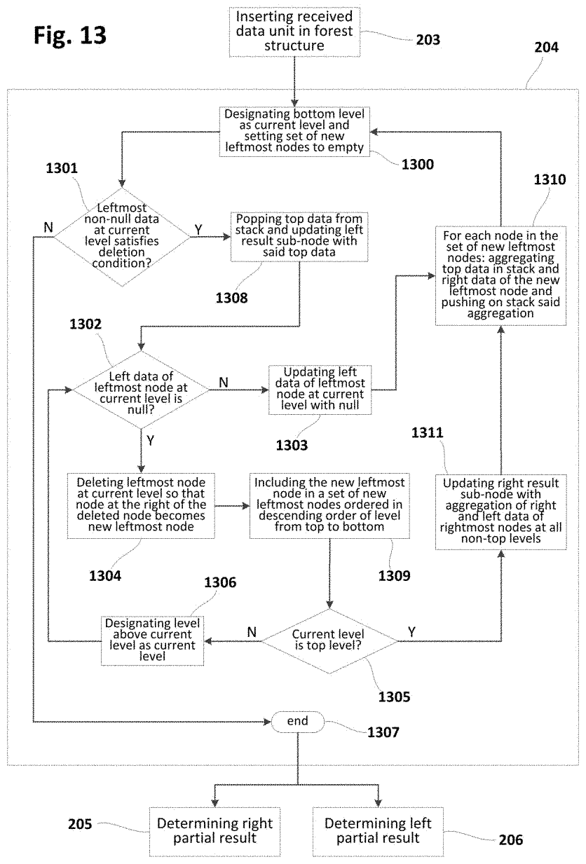

FIG. 13 is a flowchart schematically illustrating a deletion sub-method similar to the deletion sub-method of FIG. 8. In particular, blocks 1300-1307 (of FIG. 13) may be equal or similar to blocks 800-807 (of FIG. 8) respectively. FIG. 13 may differ from FIG. 8 in blocks 1308-1311 which are aimed at incrementally updating a result node including pre-calculated right and left partial results. Said right and left partial results may be understood as partial aggregations corresponding to respective right and left portions of the forest whose combination results in the whole forest. Another difference between FIG. 13 and FIG. 8 may be that, in the former, block 1300 further includes initializing a set of new leftmost nodes to empty.

As illustrated in FIG. 13, a stack may be used to efficiently update left partial result in result node. This stack may have been previously updated according to sub-methods described in present disclosure (see e.g. FIG. 6 and corresponding description). Deletion of nodes according to FIG. 13 (or similar) may permit determining left and right partial results by retrieving them from result node (blocks 205 and 206 of FIG. 2). Final result (or aggregation) may thus be determined by aggregating said retrieved left and right partial results (block 207 of FIG. 2).

At block 1308, top data in stack may be popped from the stack and left result sub-node (in result node) may be updated with said top data, once it has been confirmed (at block 1301) that leftmost non-null data at current/bottom level satisfies corresponding deletion condition. The different manners in which the stack can be updated that are described in present disclosure provoke that top data in the stack always coincides with partial aggregation corresponding to left portion of the forest (as previously defined) without the leftmost non-null data that is to be deleted (since it satisfies deletion condition). In other words, top data in the stack corresponds to current left partial result without including the leftmost non-null data (at bottom level) that is to be deleted.

As defined in other parts of the description, deletion condition may correspond to a restricted count of existing updates (or data units) in the window, a restricted lapse of production time of updates (or data units) in the window, etc.

At block 1309, once leftmost node at current level has been deleted (at block 1304) and, therefore, node at the right of the deleted node has become new leftmost node, said new leftmost node may be included in the set of new leftmost nodes. This set may be ordered in descending (top-down) order of level. This ordered set of new leftmost nodes will permit updating the stack (at block 1310) in such a way that top data in the stack always corresponds to current left partial result without including the leftmost non-null data at bottom level to be deleted (or to be set to null). Once block 1309 has been completed, the sub-method may continue to block 1305.

At block 1311, if single node at top level of the forest has been deleted and, therefore, a new iteration is to be performed starting again from bottom level, right result sub-node (in result node) may be updated with aggregation of right and left data of rightmost nodes at non-top levels. Hence, right partial result is corrected with consistent value only when partial aggregation corresponding to the right portion of the forest (as defined above) may have been distorted, i.e. when single node at top level has been deleted. Once right partial result has been corrected in result node, the sub-method may proceed to block 1310.

At block 1310, once left data of leftmost node at current level has been updated with null or right partial result has been corrected in result node, the stack may be updated depending on which new leftmost nodes have resulted in previous iterations. To this end, nodes in the set of new leftmost nodes (updated at block 1303) may be processed from first to last in descending (top-down) order of level (as defined with reference to block 1309). In particular, for each of the new leftmost nodes in the set (from first to last) an aggregation of top data in stack and right data in the new leftmost node may be determined, and said aggregation may be pushed on the stack. This way, track of new leftmost nodes that have resulted from deleting corresponding previous leftmost nodes is kept in the stack, in such a way that top data in the stack always corresponds to current left partial result without including the leftmost non-null data to be deleted (or to be set to null) at bottom level. Once stack has been suitably updated, a transition to block 1300 may be performed in order to initiate a new iteration starting again from bottom level.

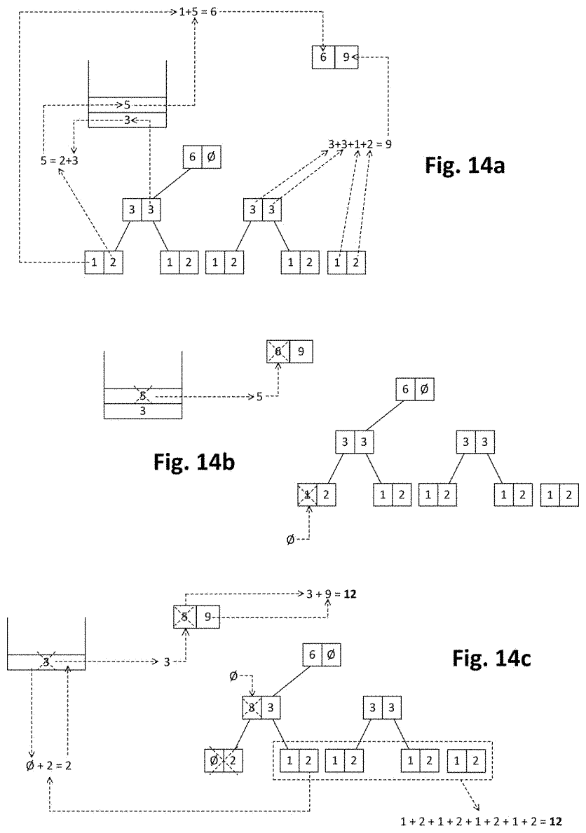

FIGS. 14a-14c show a window with corresponding forest, result node and stack and their evolution due to execution of a deletion sub-method such as the one of FIG. 13 or similar. FIG. 14a illustrates an initial window resulting from executing a method according to the present disclosure. Result node is shown with left partial result equal to ‘6’ and right partial result equal to ‘9’.

Right partial result may have been determined from an aggregation of left and right data of rightmost nodes at non-top levels. In the particular case illustrated, right partial result may correspond to an aggregation of a first aggregation ‘1’+‘2’ (left and right data in rightmost node at bottom level) and a second aggregation ‘3’+‘3’ (left and right data in rightmost node at intermediate level). Accordingly, right partial result ‘9’ may result from the aggregation ‘1’+‘2’+‘3’+‘3’=‘9’. As described in other parts of the disclosure, right partial result may have been determined incrementally during insertion of received data units in the window/forest.

Left partial result ‘6’ may have been determined from an aggregation of top data in stack ‘5’ and leftmost non-null data at bottom level ‘1’ (‘1’+‘5’=‘6’). Top data in stack ‘5’ may have been determined by aggregating right data of leftmost node at bottom level ‘2’ and previous top data in stack ‘3’ (‘5’=‘2’+‘3’). Said previous top data in stack ‘3’ may have been determined by aggregating right data of leftmost node at intermediate level ‘3’ and initial top data in stack ‘Ø’ (stack was empty at this point, which implies that top data was ‘Ø’) (‘3’=‘3’+‘Ø’). Only leftmost nodes at bottom and intermediate levels have been considered in these calculations because said nodes have left and right data different from null or ‘Ø’. Node at top level has not been considered because said node has one of the left and right data different from null (left data=‘6’ and right data=‘Ø’).

FIG. 14b shows an evolution of the forest from previous FIG. 14a according to principles of deletion sub-method according to FIG. 13. It may be verified, at block 1301, that leftmost non-null data (i.e. left data of leftmost node ‘1’) at current/bottom level satisfies deletion condition. Then, at block 1308, top data in stack ‘5’ may be popped from the stack and left partial result in result node may be updated with said top data ‘5’. Afterwards, it may be verified, at block 1302, that left data of leftmost node at current/bottom level is not null, in which case said left data may be updated with null ‘Ø’ at block 1303. Next, since no new leftmost node has arisen because no complete leftmost node has been deleted and, therefore, set of new leftmost nodes is empty, nothing may be done according to block 1310. A loop back to block 1300 may then be performed for initiating new iteration starting again from bottom level.

FIG. 14c shows an evolution of the forest from previous FIG. 14b according to principles of same deletion sub-method. It may be verified, at block 1301, that leftmost non-null data (i.e. right data of leftmost node ‘2’) at current/bottom level satisfies deletion condition. Then, at block 1308, top data in stack ‘3’ may be popped from the stack and left partial result in result node may be updated with said top data ‘3’. Afterwards, it may be verified, at block 1302, that left data of leftmost node at current/bottom level is null, in which case said leftmost node may be deleted at block 1304, so that next node at the right of the deleted node becomes new leftmost node. Next, said new leftmost node <‘1’,‘2’> may be included, at block 1309, in set of new leftmost nodes. Then, at block 1305, it may be verified that current level is not top level, in which case a transition to next level upwards may be performed at block 1306. A loop back to block 1302 may be performed in order to start new iteration at said next level upwards (intermediate level).

At block 1302, it may be verified that left data of leftmost node at current/intermediate level is not null, in which case said left data may be updated with null ‘Ø’. Next, the only element that has been included in the set of new leftmost nodes (at block 1309 in previous iteration) may be processed according to block 1310. In particular, aggregation of top data in stack (=‘Ø’ because stack is empty at this point) and right data of said new leftmost node ‘2’ may be determined, and said aggregation (‘Ø’+‘2’=‘2’) may be pushed on the stack. A loop back to block 1300 may be then performed for initiating new iteration starting again from bottom level.

FIG. 14c further shows that, after several deletions as described above, final aggregation of whole window (‘1’+‘2’+‘1’+‘2’+‘1’+‘2’+‘1’+‘2’=‘12’) may be determined by aggregating left partial result ‘3’ and right partial result ‘9’ (‘3’+‘9’=‘12’).

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A computer system for distributed storage of data structured as a forest of balanced trees of one or more nodes, each node including a plurality of data-elements, and the forest comprising a plurality of levels including a top level and a bottom or leaf level;
the nodes in the forest comprising first end nodes at a first side of the forest, second end nodes at a second side of the forest, and intermediate nodes between the first and second end nodes; and the computer system comprising
a memory to store at least the first and second end nodes;
a connector to implement a connection with a storage system configured to store intermediate nodes of the forest, so that exchange of nodes with the storage system is performed through said connexion;
a processor to update the nodes stored in the memory according to updating criteria, and to exchange nodes with the storage system through the connection according to exchange criteria.

2. A computer system according to claim 1, the storage system being comprised in the computer system.

3. A computer system according to claim 1, the storage system being external to the computer system.

4. A computer system according to claim 3, the storage system being located at a remote site with respect to the computer system.

5. A computer system according to claim 4, the connector of the computer system being configured to implement a connection with a communications network for connecting the computer system with the storage system through said communications network.

6. A computer system according to a claim 1, the memory being configured to further store a first number of consecutive intermediate nodes neighbouring the first end node, and a second number of consecutive intermediate nodes neighbouring the second end node, at each of those levels exceeding a predefined number of nodes.

7. A computer system according to claim 1, each of the first end nodes being a root node of a tree in the forest.

8. A computer system according to claim 1, the updating criteria comprising using an aggregation function, the aggregation function including associativity and a neutral or null element.

9. A computer system according to claim 8, all data-elements in all intermediate nodes being different from null.

10. A computer system according to claim 8, each of the first end nodes at non-top levels either having all data-elements different from null, or having consecutive data-elements different from null and consecutive data-elements equal to null, the non-null data-elements being farther and the null data-elements being closer with respect to the first side of the forest.

11. A computer system according to claim 8, each of the second end nodes at non-top levels either having all data-elements different from null, or having consecutive data-elements different from null and consecutive data-elements equal to null, the non-null data-elements being farther and the null data-elements being closer with respect to the second side of the forest.

12. A computer system according to claim 8, the forest being updated using a streaming application, the streaming application being based on a data stream providing data units to be aggregated in a sliding window.

13. A computer system according to claim 12, non-null data-elements in nodes at the bottom level corresponding to data units received from the data stream, and aggregation of said non-null data-elements corresponding to final aggregation of the sliding window.

14. A computer system according to claim 13, non-null data-elements in nodes at non-bottom levels corresponding to partial aggregations of the sliding window.

15. A computer system according to claim 14, non-null data-elements in intermediate nodes corresponding to partial aggregations that are included in partial aggregations corresponding to non-null data-elements in end nodes.

16. A computer system according to claim 15, aggregation of at least some of the non-null data-elements in end nodes corresponding to final aggregation of the sliding window.

17. A computer system according to claim 12, the data stream including sensor data produced by a sensor site including one or more sensors.

18. A computer system according to claim 17, the sensor site being included in the computer system.

19. A computer system according to claim 12, the data units to be aggregated in the sliding window being provided by a plurality of data streams.

20. A computer system according to claim 1, the trees of the forest being binary trees.

21. A computer system according to claim 1, distributed storage of a forest of balanced trees including distributed storage of a plurality of forests of balanced trees.

22. A computer system according to claim 1, the computer system being comprised in a network of computer systems including one or more other computer systems for distributed storage of one or more other forests of balanced trees.

23. A storage system for distributed storage of data structured as a forest of balanced trees of one or more nodes, each node including a plurality of data-elements, and the forest comprising a plurality of levels including a top level and a bottom or leaf level;
the nodes in the forest comprising first end nodes at a first side of the forest, second end nodes at a second side of the forest, and intermediate nodes between the first and second end nodes; and the storage system comprising
a memory to store at least some of the intermediate nodes;
a connector to implement a connection with a computer system configured to store and update at least the first and second end nodes of the forest, so that exchange of nodes with the computer system is performed through said connection.

24. A system for distributed storage of data structured as a forest of balanced trees, the system comprising a computer system according to claim 1, and a storage system for distributed storage of data structured as a forest of balanced trees of one or more nodes, each node including a plurality of data-elements, and the forest comprising a plurality of levels including a top level and a bottom or leaf level;
the nodes in the forest comprising first end nodes at a first side of the forest, second end nodes at a second side of the forest, and intermediate nodes between the first and second end nodes; and the storage system comprising
a memory to store at least some of the intermediate nodes;
a connector to implement a connection with a computer system configured to store and update at least the first and second end nodes of the forest, so that exchange of nodes with the computer system is performed through said connection
the computer system and storage system being connectable with each other through a connection between the connector of the computer system and the connector of the storage system.

25. A method of updating distributed data structured as a forest of balanced trees of one or more nodes, each node including a plurality of data-elements, and the forest comprising a plurality of levels including a top level and a bottom or leaf level;
the nodes in the forest comprising first end nodes at a first side of the forest, second end nodes at a second side of the forest, and intermediate nodes between the first and second end nodes; and the method comprising
storing, by a processor of a computer system, at least the first and second end nodes into a memory of the computer system;
updating, by the processor, the nodes stored in the memory according to updating criteria;
exchanging, by the processor, nodes with a storage system through a connection according to exchange criteria, the storage system being configured to store intermediate nodes of the forest, and the connection being implemented through a connector of the computer system.

26. A method according to claim 25, the forest being updated using a streaming application, the streaming application being based on a data stream providing data units to be aggregated in a sliding window.

27. A method according to claim 26, the updating the nodes stored in the memory comprising inserting, by the processor, a received data unit in the forest by updating the first end nodes with corresponding partial aggregations resulting from said insertion.

28. A method according to claim 27, the exchanging nodes with the storage system comprising sending to the storage system, by the processor, a corresponding intermediate node when insertion of a data unit provokes creation of a new first end node and transformation of a first end node to intermediate node.

29. A method according to claim 26 the updating the nodes stored in the memory comprising deleting, by the processor, one or more previously inserted data unit by updating the second end nodes with corresponding partial aggregations resulting from said deletion.

30. A method according to claim 29, the exchanging nodes with the storage system comprising retrieving from the storage system, by the processor, a corresponding intermediate node when deletion of a data unit provokes deletion of an existing second end node and transformation of an intermediate node to new second end node.

31. A computer program comprising program instructions for causing a computer system to perform a method according to claim 25 for distributed storage of data structured as a forest of balanced trees.

32. A computer program product according to claim 31, embodied on a storage medium.

33. A computer program product according to claim 31, carried on a carrier signal.
